(19) United States
(12) Patent Application Publication
(10) Pub. No.: US 2005/0019668 A1
(43) Pub. Date: Jan. 27, 2005

(54) Ionic conduction structural member, secondary battery and method of producing same

(75) Inventors: Tomoya Yamamoto, Fukui (JP); Soichiro Kawakami, Kanagawa (JP); Toshifumi Akasaka, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/872,419

(22) Filed: Jun. 22, 2004

(30) Foreign Application Priority Data
Jun. 24, 2003 (JP) 2003-179404

(51) Int. Cl. H01M 10/40; H01M 4/58; C08J 5/22

(52) U.S. Cl. 429/317; 521/27; 429/231.95; 429/231.4

(57) ABSTRACT

An ionic conduction structural member with a high ionic conductivity and a high charge/discharge efficiency and a secondary battery using the same are provided. The ionic conduction structural member comprises a polymer matrix, a solvent as a plasticizer and an electrolyte, wherein the polymer matrix comprises a polymer chain comprising a segment represented by the following general formula (1) and a segment represented by the following general formula (2): 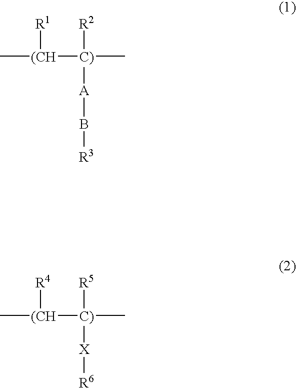
(wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more), and wherein a main chain part of the polymer chain and the side chain part of the general formula (1) have an orientation property and a crosslinked structure.

### BACKGROUND OF THE INVENTION

1. Field of the Invention

The present invention relates to an ionic conduction structural member, a secondary battery and a method of producing the same. More particularly, the present invention relates to an ionic conduction structural member with a high ionic conductivity and a high charge/discharge efficiency and a method of producing the same, and a secondary battery using the ionic conduction structural member and a method of producing the same.

2. Related Background Art

Recently, the amount of atmospheric carbon dioxide is increasing and there is a fear of global warming caused by resulted green house effect, as a result, countermeasures for reducing the exhaust amount of carbon dioxide gas are on going in worldwide scale. For example, since a large amount of carbon dioxide gas is exhausted in thermal power plants, in which thermal energy obtained by burning the fossil fuel is converted to an electric energy, newly constructing a thermal power plant becomes quite difficult. Accordingly, in order to take measures against increasing demand for the electric power, the so-called load leveling is proposed. Namely, the nighttime electric power, the dump power, is stored in secondary batteries built at home for effective use of electric power, and is used in a daytime for balancing the load when the power consumption is high. Further, since automobiles driven by fossil fuel exhaust NOx, SOx, hydrocarbon, etc. in addition to carbon dioxide gas, it is regarded as another origin of air pollutants. From the viewpoint of making smaller generation of air pollutants, electric vehicles moving with a driving motor by means of electricity stored in the secondary battery is focused attention due to no exhaustion of air pollutants, and the research and development for early practical use are widely in progress. With regard to secondary batteries for use of load leveling and electric vehicles, it is required to have a high energy density, a long life and a low cost.

Further, with regard to secondary batteries used for power supplies of portable equipment such as notebook computers, word processors, video cameras and cellular phones, supplying small-sized, lightweight and high-performance secondary batteries is demanded.

As for the high performance secondary battery for satisfying such demands, since the secondary battery using intercalation compounds of lithium-graphite as a negative electrode was reported in Journal of the Electrochemical Society, 117, 222 (1970), rocking chair type secondary batteries comprising using carbon (including graphite) as a negative electrode active material as well as using an intercalation compound introduced with lithium ions as a positive electrode active material and intercalating and storing the lithium into between layers of the carbon by the charging reaction, i.e. the so-called “lithium ion battery”, has been developed and practically used. In this type of lithium ion battery, as a result of using the negative electrode of carbon, a host material intercalating the lithium as a guest into between layers thereof, growth of a dendrite of lithium during charging is suppressed to achieve a long life in the charge/discharge cycle.

However, in the secondary battery using a cell reaction by lithium ions (charging/discharging reactions) such as the above lithium ion secondary battery, since an organic solvent is used as a solvent for an electrolyte solution, overcharging causes decomposition of the solvent to generate carbon oxide gas, hydrocarbon, etc. and any recombination reaction causes no reverse reaction to the original solvent, and as a result, there is a fear to increase the internal impedance due to degradation of the electrolyte solution. Further, overcharging develops an internal short-circuit of the battery to generate heat with a rapidly progressing decomposition reaction of the solvent to cause a lowering of the performance of the secondary battery.

In order to solve the problems of the decomposition and degradation of the electrolyte solution in the secondary battery using charging/discharging reaction with lithium ions, an ionic conductor obtained by copolymerizing three types of monomers of diacrylates, monoacrylates and acrylates containing carbonate groups in the presence of an organic solvent and a supporting electrolyte is proposed in U.S. Pat. No. 5,609,974. In order to prevent leakage of an electrolyte solution, Japanese Patent Application Laid-Open No. H5-25353 proposes an ionic conductor using a polymer skeleton obtained by copolymerizing three types of monomers of diacrylates, monoacrylates and vinylene carbonate. Since these ionic conductors have lower ionic conductivities that are ¼ or less of that of a liquid electrolyte solution, when these are used for the secondary battery, there is a problem to reduce the energy density.

As a result of experimental examination by the present inventors, the above proposals were found to pose the problems that materials having required strength in production and use of the secondary battery could not be obtained, and further that the ionic conductivity was more greatly reduced at a lower temperature than at ordinary temperature and the energy density was also rapidly reduced.

In Japanese Patent Publication No. H7-95403, a two-dimensionally crosslinked ionic conductor using a lipid was proposed. Japanese Patent Application Laid-Open No. H7-224105 proposes an ionic conductor having a double continuous structure with continued hydrophilic polymer phase and hydrophobic polymer phase by using a surfactant. However, there are further problems in these proposals that complete removal of a lipid or surfactant is difficult in a washing step, and a remaining lipid or surfactant may worsen the cyclic life. Further, since it contains a lipid or surfactant that is not bonded to a polymer skeleton, the mechanical strength of the obtained ionic conductor required for processing is small, and the removal of the lipid or surfactant in the washing step may generate a vacant wall, which results in further degradation of the strength.

As for a method of improvement the mechanical strength of an ionic conductor, Japanese Patent Application Laid-Open No. H5-299119 proposes an ionic conductor consisting of a highly polar polymer phase and a less polar polymer phase. However, since the less polar polymer phase of the supporting phase does not function as an ionic conduction phase, there is a problem that the ionic conductivity of the ionic conductor is low. Further, Japanese Patent No. 3045120 proposes an ionic conductor comprising a liquid crystalline compound using an alkylene oxide derivative having a substituent. Japanese Patent Application Laid-Open No. H5-303905 proposes an ionic conductor prepared by curing monomers having polyether groups. However, these ionic conductors have still problems of a low ionic conductivity since they have low ionic diffusibilities due to their irregular polymer skeletal structures.

In Japanese Patent Application Laid-Open Nos. H11-302410, 2000-212305 and 2000-119420, the orientation type ion-exchange membranes consisting of specific monomer structures are proposed. According to these proposals, although an effect can be obtained in a state without containing a plasticizer, formation of a polymer skeletal structure having a regularity in the ionic conduction structural member, which requires essentially a plasticizer such as a solvent, is insufficient, and attaining an ionic conduction structural member having a high ionic conductivity is difficult.

Japanese Patent Application Laid-Open No. H5-214247 proposes an ionic conduction structural member in which an acrylate of a block copolymer of alkylene oxide is polymerized. Further, Japanese Patent Application Laid-Open No. H9-147912 proposes a gelatinous ionic conduction structural member that is obtained by polymerization of ethylene oxide/propylene oxide/block polyether/diacrylate. Although these ionic conduction structural members have mechanical strength, it is difficult to increase content of a solvent, which is a plasticizer in the ionic conduction structural member important for attaining a high ionic conductivity. Further, these ionic conductors still have problems of low a ionic conductivity since they have low ionic diffusibilities due to their irregular polymer skeletal structures, and especially the ionic diffusion is greatly inhibited by the irregular polymer skeletal structure in low-temperature use, resulting in a serious lowering in the ionic conductivity.

Although the present inventors have proposed a secondary battery having orientated ion channels in order to improve the cycle life in Japanese Patent Application Laid-Open No. H11-345629, it is still highly demanded to provide an ionic conduction structural member, which can be produced by a simple method at a low cost, with a high ionic conductivity having an excellent mechanical strength.

### SUMMARY OF THE INVENTION

The present invention has been accomplished in view of the above-mentioned problems in the prior art. It is, therefore, an object of the present invention to provide an ionic conduction structural member that can be produced by a simple method at a low cost, is free from a lowering in ionic conductivity even at a low temperature, and has a high ionic conductivity and an excellent mechanical strength, and a secondary battery having a high capacity in use at a low temperature and good performance of cycle life. It is another object of the present invention to provide methods of producing the above ionic conduction structural member and the secondary battery.

The ionic conduction structural member of the present invention is an ionic conduction structural member with a crosslinked structure comprising a polymer matrix, a solvent as a plasticizer and an electrolyte, wherein the polymer matrix comprises a polymer chain comprising a segment represented by the following general formula (1) and a segment represented by the following general formula (2): 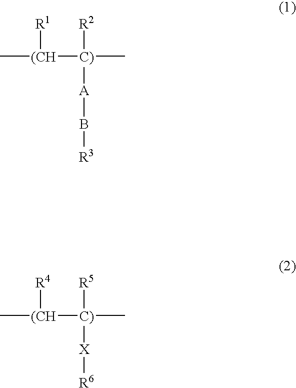
(wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more), and wherein a main chain part of the polymer chain and the side chain part of the general formula (1) have an orientation property.

The method of producing an ionic conduction structural member of the present invention is a method of producing an ionic conduction structural member comprising a polymer matrix, a solvent as a plasticizer and an electrolyte, which comprises, in sequence, the steps of:

(a) mixing a monomer represented by the following general formula (3) and a monomer represented by the following general formula (4): 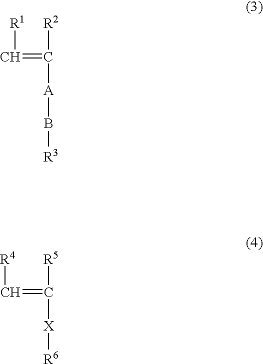
(wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more) with a solvent and an electrolyte; and

(b) subjecting the mixture obtained by the step (a) to a polymerization reaction to prepare a polymer matrix.

The secondary battery of the present invention is a secondary battery comprising an ionic conductor between a positive electrode and a negative electrode provided in opposition to each other, wherein the above-mentioned ionic conduction structural member is used as the ionic conductor and is disposed such that the ionic conductivity is higher in a direction connecting a surface of the negative electrode and a surface of the positive electrode.

The method of producing the secondary battery of the present invention is a method of producing a secondary battery comprising an ionic conductor between a positive electrode and a negative electrode provided in opposition to each other, which comprises the steps of forming, as the ionic conductor, an ionic conduction structural member by the above-mentioned method of producing an ionic conduction structural member and disposing the ionic conduction structural member such that the ionic conductivity is higher in a direction connecting a surface of the negative electrode and a surface of the positive electrode.

The present invention will be described in detail below. As described above, the ionic conduction structural member of the present invention has a crosslinked structure and comprises a polymer matrix, a solvent as a plasticizer and an electrolyte, wherein the polymer matrix comprises a polymer chain comprising a segment represented by the above-mentioned general formula (1) and a segment represented by the above-mentioned general formula (2), and wherein a main chain part of the polymer chain and the side chain part of the general formula (1) have an orientation property.

In the present invention, it is preferable that the orientation direction of the side chain part of the general formula (1) of the polymer chain is perpendicular to the orientation direction of the main chain of the polymer chain.

Further, it is preferable that the ionic conduction structural member has an anisotropic ionic conductivity.

Moreover, it is preferable that m and n of the above general formula (1) are independently an integer of 5 to 100 with an integer of 10 to 50 being more preferable.

Further, it is preferable that k of the above general formula (2) is an integer of 2 to 100 with an integer of 3 to 30 being more preferable.

Moreover, it is preferable that the ratio of the —CH₂—CH₂—O— group and the —CH₂—CH(CH₃)—O— group contained in the polymer matrix represented by (the total number of the —CH₂—CH₂—O— groups contained in the entire polymer matrix)/(the total number of the —CH₂—CH(CH₃)—O— groups contained in the entire polymer matrix) is 0.5 to 20 with the ratio of 1.0 to 10 being more preferable.

Further, it is preferable that the content of the solvent as the plasticizer in the ionic conduction structural member is 70 to 99% by weight with 80 to 99% by weight being more preferable.

Moreover, it is preferable that the solvent is an aprotic polar solvent. Preferable examples of the aprotic polar solvent include ethers, carbonates, nitriles, amides, esters, nitro compounds, sulfur compounds and halides. These can be used alone or in combination of two or more.

Further, it is preferable that the electrolyte is a lithium salt.

Moreover, it is preferable that the ionic conduction structural member contains a support. The support may be at least one selected from the group consisting of resin powder, glass powder, ceramic powder, nonwoven fabric and a porous film. At this time, it is preferable that the content of the support is 1 to 50% by weight.

As described above, the method of producing an ionic conduction structural member of the present invention is a method of producing the above-mentioned ionic conduction structural member comprising a polymer matrix, a solvent as a plasticizer and an electrolyte, which comprises, in sequence, the steps of:

(a) mixing a monomer represented by the following general formula (3) and a monomer represented by the following general formula (4): 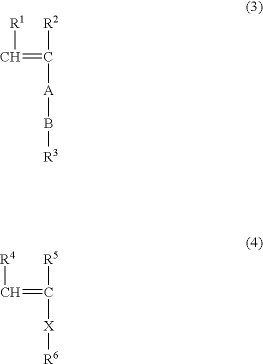
(wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more) with a solvent and an electrolyte; and

(b) subjecting the mixture obtained by the step (a) to a polymerization reaction to prepare a polymer matrix.

It is preferable that in the step (a), a polymerization initiator is further admixed.

Further, it is preferable that a step is further included in which a crosslinked structure is formed by a crosslinking reaction in the polymer matrix prepared by the step (b), and that the thus formed crosslinked structure is formed through covalent bonding. In this case, it is preferable that in the above step (a), a monomer that can form a crosslinked structure is mixed, and that the polymerization reaction in the above step (b) comprises a crosslinking reaction.

Further, it is preferable that m and n of the above general formula (3) are independently an integer of 5 to 100 with an integer of 10 to 50 being more preferable.

Moreover, it is preferable that k of the above general formula (4) is an integer of 2 to 100 with an integer of 3 to 30 being more preferable.

Further, it is preferable that in the step (a), the above general formula (3) and the above general formula (4) is mixed such that (the total number of the —CH₂—CH₂—O— groups contained in the entire polymer matrix)/(the total number of the —CH₂—CH(CH₃)—O— groups contained in the entire polymer matrix) is 0.5 to 20, with the ratio of 1.0 to 10 being more preferable.

Moreover, it is preferable that the solvent used in the above step (a) is an aprotic polar solvent. Preferable examples of the aprotic polar solvent include ethers, carbonates, nitriles, amides, esters, nitro compounds, sulfur compounds and halides. These may be used alone or in combination of two or more.

Further, it is preferable that the electrolyte used in the step (a) is a lithium salt.

Moreover, it is preferable that the polymerization reaction in the above step (b) uses a thermal energy.

Further, it is preferable that the above-mentioned production method includes the step of incorporating a support comprising at least one selected from the group consisting of resin powder, glass powder, ceramic powder, nonwoven fabric and a porous film into the ionic conduction structural member. At this time, it is preferable that the content of the support in the ionic conduction structural member is 1 to 50% by weight.

As described above, the secondary battery of the present invention is a secondary battery comprising an ionic conductor between a positive electrode and a negative electrode provided in opposition to each other, wherein the above-mentioned ionic conduction structural member is used as the ionic conductor and is disposed such that the ionic conductivity is higher in a direction connecting a surface of the negative electrode and a surface of the positive electrode.

It is preferable that at least one of the negative electrode and the positive electrode comprises an ionic conduction structural member, which is preferably the ionic conduction structural member as described above.

Further, it is preferable that the negative electrode comprises a substance that incorporates lithium ions in a charging reaction and releases lithium ions in a discharging reaction, and that the positive electrode comprises a substance that releases lithium ions in the charging reaction and incorporates lithium ions in the discharging reaction.

As described above, the method of producing a secondary battery of the present invention is a method of producing a secondary battery comprising an ionic conductor between a positive electrode and a negative electrode provided in opposition to each other, which comprises the steps of forming, as the ionic conductor, an ionic conduction structural member by the above-mentioned method of producing an ionic conduction structural member and disposing the ionic conduction structural member such that the ionic conductivity is higher in a direction connecting a surface of the negative electrode and a surface of the positive electrode.

In the method of producing a secondary battery of the present invention, it is preferable that the ionic conduction structural member is formed on at least one of the negative electrode and the positive electrode, and the negative electrode and the positive electrode are disposed in opposition to each other with the thus formed ionic conduction structural member therebetween. In addition, the production method may include the step of forming the negative electrode by incorporation of the ionic conduction structural member or the step of forming the positive electrode by incorporation of the ionic conduction structural member.

At this time, it is preferable that a material for forming the negative electrode active material layer or the positive electrode active material layer is impregnated with a solution comprising at least one selected from the group consisting of a polymer, a monomer and an oligomer as a material for the polymer matrix constituting the ionic conduction structural member so as to form the polymer matrix constituting the ionic conduction structural member in the formed active material layer. At this time, it is preferable that the polymer matrix is formed by a polymerization reaction alone or a combination of a polymerization reaction and a crosslinking reaction.

Incidentally, it is preferable that when the negative electrode active material layer or the positive electrode active material layer is prepared so as to contain the ionic conduction structural member, the ionic conduction structural member as preliminarily prepared is mixed with a negative electrode active material or a positive electrode active material and the mixture is disposed on a given current collector to form the electrode active material layer.

### BRIEF DESCRIPTION OF THE DRAWINGS

FIGS. 1A and 1B are views schematically showing the polymer structure of the ionic conduction structural member of the present invention;

FIG. 2 is a flowchart showing the production method of the present invention;

FIG. 3 is schematic views showing a polymerization vessel used in the production method of the present invention;

FIG. 4 is a sectional view showing an example of the secondary battery of the present invention;

FIG. 5 is a sectional view showing another example of the secondary battery of the present invention;

FIG. 6 is a profile view for showing the result of X-ray small angle scattering measurement of the ionic conduction structural member prepared in Example 1 of the present invention;

FIG. 7 is a schematic view of a system for measuring the impedance of an ionic conduction structural member in examples;

FIG. 8 is a view showing the correlation between the number of ethylene oxides in polyethylene oxide group of segment having polyethylene oxide group and polypropylene oxide group in side chain constituting the ionic conduction structural member of the present invention and the orientation property of the ionic conduction structural member;

FIG. 9 is a view showing the correlation between the number of propylene oxides in polypropylene oxide group of segment having polyethylene oxide group and polypropylene oxide group constituting the ionic conduction structural member of the present invention and the orientation property of the ionic conduction structural member; and

FIG. 10 is a view showing the correlation between the ratio of the total number of —CH₂—CH₂—O— groups contained in the entirety of a polymer matrix constituting the ionic conduction structural member of the present invention to the total number of —CH₂—CH(CH₃)—O— groups contained in the entirety of the polymer matrix and the orientation property of the ionic conduction structural member.

### DESCRIPTION OF THE PREFERRED EMBODIMENTS

Preferred embodiments of the present invention will be described with reference to the attached drawings. The following embodiments are not, however, intended to limit the scope of the present invention.

(Ionic Conduction Structural Member)

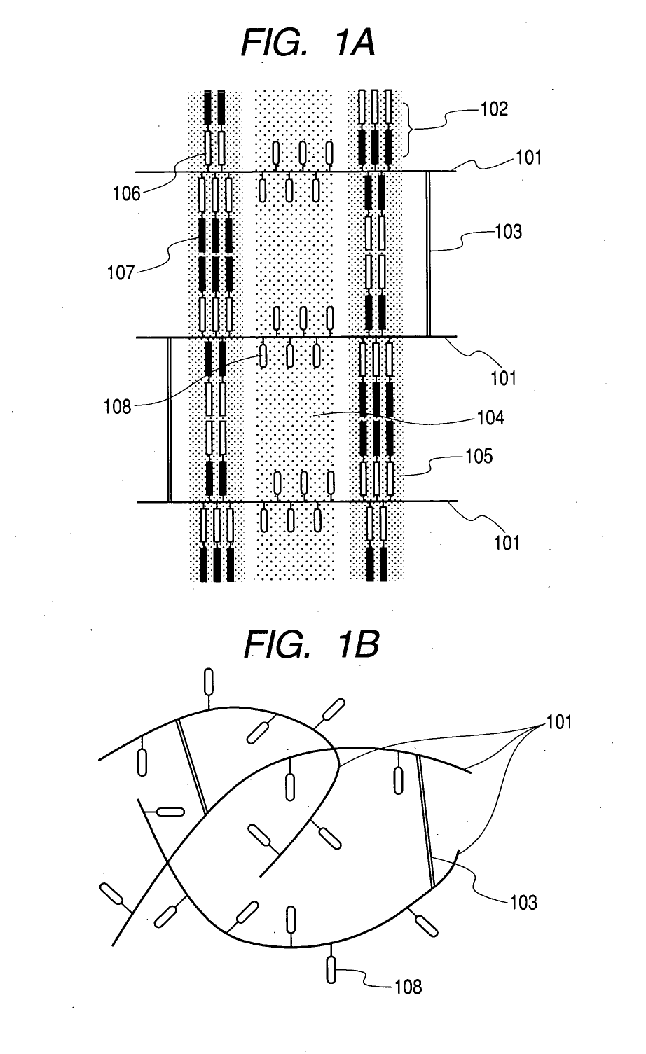

Embodiments of the ionic conduction structural member of the present invention are explained by referring to FIGS. 1A and 1B.

The ionic conduction structural member of the present invention is an ionic conduction structural member mainly comprised of the polymer matrix, solvent as the plasticizer and electrolyte, namely is the ionic conduction structural member in which the polymer matrix is gelatinously plasticized by the solvent.

With this structure, the inventors have found that the ionic conduction structural member with a higher ionic conductivity without a lowering in mechanical strength can be prepared by a simple method, since the main chain part and the side chain part of the general formula (1) in the polymer chain have the orientation property, even in a high content of the solvent in the ionic conduction structural member, by constituting the polymer matrix of the polymer chain having the crosslinked structure containing at least the segment represented by the following general formula (1) and the segment represented by the following general formula (2). Further, the inventors have found that a lithium secondary battery having a high capacity, a high charging/discharging efficiency even at a low temperature and a long life can be achieved by using the ionic conduction structural member. The present invention is based on these findings.

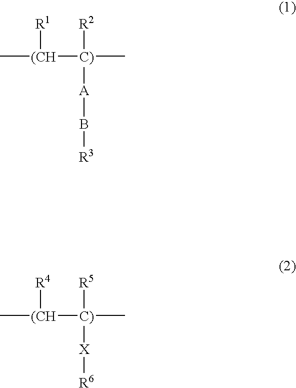

In the above formulae, R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ— A and B each forming a block; X is a group comprising —(CH₂—CH₂—O)ₖ—; m and n are independently an integer of 3 or more; and k is an integer of 1 or more.

The reason why the technical effect described above is exhibited is believed to be as follows.

FIGS. 1A and 1B are schematic diagrams showing one embodiment of the polymer structure of the ionic conduction structural member of the present invention. As shown in FIG. 1A, the side chain part 102 and the main chain part 101 of the polymer chain, composing together a polymer matrix, are oriented respectively to form a regular skeletal structure of the polymer chain. Further, since the polymer chain constituting the ionic conduction structural member of the present invention forms crosslinked bonds 103, a strong skeletal structure having a stereoregularity can be formed, and the ionic conduction structural member with an excellent mechanical strength is considered to be able to be obtained. As shown in FIG. 1A, as a result of orientating the side chain part containing the polyethylene oxide group (—(CH₂—CH₂—O)ₘ—) 106 and the polypropylene oxide group (—(CH₂—CH(CH₃)—O)ₙ—) 107 in a constant direction, the ethylene oxide groups 108 having a high affinity to the solvent contained in the ionic conduction structural member are arranged and the ionic conduction path A 104 is formed in the constant direction, as a result, ions can easily be moved in the direction of the ionic conduction path as compared with the structure shown in FIG. 1B, in which ethylene oxide groups are irregularly arranged without having orientation property, so that the ionic conductivity is considered to be improved.

Specifically, when the ionic conduction path A 104 is formed in the constant direction as shown in FIG. 1A, ions can easily be moved along the path. However, if any conduction path of ions is not established regularly as shown in FIG. 1B, since ions can move to various directions (since there are not only ions moving the shortest distance but also ions moving by a long distance while making a detour), and as a result, moving paths of ions become longer. Since the ionic conductivity becomes larger in proportion to the ion concentration and the moving rate of the ions in the interelectrode direction, if the numbers of ions in a constant space of the ionic conduction structural member and the ionic mobility are the same, ions in a shorter moving path will have a larger moving rate in the interelectrode direction, so that the ionic conductivity becomes higher. However, in FIG. 1A, the ionic conduction paths are arranged in the specific direction, so that the ionic moving paths can be made shorter, whereby the ionic conductivity is improved to show anisotropy in the ionic conduction.

Further, also in the portion where the side chain parts containing the polyethylene oxide group 106 and the polypropylene oxide group 107 are oriented in FIG. 1A, since the polyethylene oxide group and the polypropylene oxide group have affinity with the solvent contained in the ionic conduction structural member, it is possible to contain more solvent than a polymer having hydrophobic groups such as an alkyl group or alkylbenzyl group having a larger numbers of carbons. For that reason, as shown in the figure, the ionic conduction path B 105 is further formed as with the ionic conduction path A 104, so that the ionic conductivity is more improved than the case where only the ionic conduction path A 104 is present.

Further, by forming in the ionic conduction structural member the network structure such as shown in FIG. 1A by crosslinking, the ionic conduction paths can exist stably without being destroyed by heating or the like, so that the thermal stability of the ionic conduction structural member is improved and the structural changes such as shrinkage of the polymer matrix when dried are difficult to occur, thereby improving the stability. Further, since such a stable network structure holds a solvent for an electrolyte stably in a large amount, an increase in the content of the solvent, namely, a decrease in the content of the polymer matrix can be attained, which makes it possible to increase the amount of the solvent and the number of ions per unit volume of the ionic conduction structural member, thereby improving the ionic conductivity.

Further, since all of the polyethylene oxide group 106, the polypropylene oxide group 107 and the ethylene oxide group 108 in the polymer matrix has affinity to the solvent, it becomes possible to further increase the content of the solvent, namely, to further decrease the content of the polymer matrix as compared with the case where the polymer matrix contains a large number of hydrophobic groups such as alkyl groups or alkylbenzyl groups having a large number of carbon atoms, thereby providing an ionic conduction structural member having a higher ionic conductivity.

With regard to the orientation of the side chain part and the main chain part which constitute the polymer matrix, it is believed that as with the case where amphiphilic molecules each having a hydrophobic group and a hydrophilic group form a bimolecular membrane of a structure in which the hydrophobic groups themselves and the hydrophilic groups themselves in the molecules face each other, respectively, the side chain parts 102 each containing the blocked polyethylene oxide group and polypropylene oxide group in the polymer matrix exhibit the same function as the above-mentioned amphiphilic molecules. This is considered as follows. The orientation of the side chain part of the polymer chain is believed to be generated by constructing a bimolecular membrane structure, which can not be attained in randomly arranged ethylene oxides and propylene oxides, by means of forming blocks of the polyethylene oxide group and the polypropylene oxide group, respectively, namely by constructing the bimolecular membrane structure, in which, as shown in FIG. 1A, highly hydrophilic, blocked polyethylene oxide groups and less hydrophilic (than polyethylene oxide group; i.e., hydrophobic), blocked polypropylene oxide groups are arranged so as to face each other, respectively in the layer structure (lamellar structure). Further, it is believed that providing the side chain with the orientation property will provide the main chain with a regularity, namely will orientate the main chain, so that the main chain part and the side chain part will each have the orientation property.

With regard to the directions of orientation of the side chain part and the main chain part, if the orientation directions are different from each other, the skeletal structure is constructed multidimensionally and stably, so that conduction paths of ions are liable to be formed, which is preferred. Further, it is more preferred that the orientation direction of the side chain part is perpendicular to the orientation direction of the main chain part as shown in FIG. 1A. In this case, since the polymer chain can be constructed so as to have a skeleton with a most stable structure, and since conduction paths of ions are formed stably, an ionic conduction structural member having a direction of a good ionic conductivity, i.e. having anisotropy in the ionic conductivity, and having an excellent mechanical strength can be obtained.

Further, in cases where the ionic conduction structural member is used in a film state for the secondary battery, if the side chain part containing the polyethylene oxide group and the polypropylene oxide group is oriented perpendicularly to a widest plane of the film, conduction paths of ions are liable to be formed in the perpendicular direction, which is preferred. Further, if the main chain part of the polymer chain is oriented parallel to the widest plane of the film, the mechanical strength of the film in the film plane direction is improved and breakage during battery production is difficult to occur, which is more preferred.

As the methods for providing such orientation, a method of forming a polymer matrix by a polymerization crosslinking reaction of monomers or a crosslinking reaction of polymers under application of a magnetic field or electric field; a method of forming a polymer matrix by a polymerization crosslinking reaction of monomers or a crosslinking reaction of polymers on a substrate subjected to a hydrophobic treatment such as rubbing or fluororesin coating; and a method of stretching a polymer matrix may be included. Further, in case that the ionic conduction structural member is used for the secondary battery, in addition to the above methods, a method of forming a polymer matrix by a polymerization crosslinking reaction of monomers or a crosslinking reaction of polymers on an electrode structure prepared by incorporating a hydrophobic binder, for example a fluororesin such as tetrafluoroethylene and polyvinylidene fluoride, and polyethylene/polypropylene resin, may also be mentioned. This is because the hydrophobic binder makes the electrode surface hydrophobic, and orientation is liable to occur as with the substrate subjected to the hydrophobic treatment such as fluororesin coating.

As a method of observing the presence/absence of the orientation property and the orientation direction, for example, following methods can be mentioned: a method with direct observation by a polarizing microscope, X-ray diffractometry, X-ray small angle scattering or electron microscope; a method of observation by combination with the above method and the result of measurement of the specific crystalline structure in the ionic conduction structural member by means of infrared absorption spectrum, nuclear magnetic resonance spectrum and thermometric analysis, and a method of observing changes before and after stretching by combining with the stretching step.

The method of observation by the polarizing microscope is exemplified by a conventional method wherein the existence of the orientation property and the direction of the orientation as well as a dispersion of the orientation state are measured by observing optical anisotropy from changes of luminosity of a sample under Cross-Nicol polarizing light.

Method of observing the orientation property by X-ray diffractometry and X-ray small angle scattering includes a method of observing diffraction or scattering pattern obtained by irradiating a sample with X-ray: namely, when a point beam X-ray is irradiated to the sample, if a spot-like Laue pattern is formed, the sample has the orientation property; if the orientation property is decreased, the pattern is changed to a ring-pattern; and if the pattern has a complete ring-pattern, no orientation property is observed.

In this case, the orientation direction can be measured by the spot-like Laue pattern. In another method, the existence and direction of orientation such as no orientation, plane orientation, uniaxial orientation and double orientation can be measured by irradiating the line beam X-ray to the sample in various directions and measuring the diffraction or scattering peak of the microcrystals.

If a sample to be measured is known to have a microcrystalline phase, when the diffraction or scattering peak is measured by irradiating X-ray in various directions including X-, Y- and Z-axes, if the peak appearing at the specific position is observed only when the X-ray is irradiated from a specific direction, the microcrystals having a lattice spacing corresponding to the peak position are existing in a direction along with the direction of the irradiation, as a result, the microcrystalline phase is suggested to orientate in the specific direction. For example, if the sample to be measured is known to have a microcrystalline phase by the following measuring methods, at first, the sample is powdered and measured for the peak position corresponding to the lattice spacing of the microcrystalline phase, and an X-ray is irradiated in every directions including X-, Y- and Z-axes to the sample while maintaining the measuring sample as it is, and the direction of irradiation in which a peak corresponding to the lattice spacing of the microcrystalline phase appears is measured. If the peak-appearing direction is only the X-axis direction of the sample when measuring by the transmission method (small-angle), the sample is uniaxially oriented in a direction along the X-axis. When the peak appears only in a direction along the XY-plane, the sample has a plane orientation in the direction parallel to the XY-plane. In case that peaks appear only in the directions of X-axis and Y-axis, the sample has a double orientation in a direction along the X-axis and the Y-axis. If peaks appear in all directions and the peak intensity ratio is constant, it means a completely disordered state, i.e. no orientation.

In case that peaks appear in all directions with different intensity ratios, it is considered to have an orientation property but have a low degree of order as a whole, namely orientation property. When the intensity ratio is measured while changing the direction for irradiation, the shape of a sample is fixed to the irradiation direction, i.e. a method of measuring a sample in a spherical form or a method of measuring a sample in a fixed form with conformity of the irradiation direction, whereby the intensity ratio can be correctly judged. Further, when the specific crystal structure of the sample varies depending on the change of temperature, for example as is the case in which the specific lattice spacing disappears by change from crystal to amorphous substance by heating, measuring the change in peak accompanying the temperature change makes it possible to observe the orientation only of the specific portion of the internal structure.

Methods for measuring the specific crystalline portion of the polymer matrix in the ionic conduction structural member include: a method of measuring existence of an absorption band specific to a crystalline portion or an intensity ratio in an infrared absorption spectrometry; a method of measurement based on a change in the peak form accompanying heating/cooling, i.e. a change between a crystalline portion having a broad peak width and a non-crystalline portion having a narrow peak width (a phenomenon in which the peak is split in a multistage fashion, since in a chemical shift of nuclear spin in a crystalline portion, in which rotation of an atomic bond is restricted, the quantity of shift due to interconfiguration with neighboring atoms is not averaged as compared with freely rotatable atoms in a non-crystalline portion) in the nuclear magnetic resonance spectrometer; a method of measurement based on the amounts of thermal energy of crystallization and melting by differential thermal analysis in a thermal analysis measuring apparatus; and a method of measurement based on the relaxation/dispersion temperature of a side chain part or a main chain part of a polymer chain and the amount of energy thereof in a viscoelasticity test.

Further, a method is also available which is based on a combination of the above measurements and a step of stretching a sample and observes the orientation property by measuring a change in peak form/intensity or amount of thermal energy before and after stretching or in a direction of stretching.

The term “orientation property” employed herein is intended to mean an orientation property observed by measurement using the above methods and to encompass a weak orientation property other than completely no orientation, but a strong orientation property is preferred. The magnitude of orientation property, i.e. orientation degree, can be determined by measuring the ratio of orientation in a specific direction with the polarizing microscope or the X-ray small angle scattering measurement apparatus as mentioned above.

The method of measuring the orientation degree in the present invention can be performed as follows. With the polarizing microscope, an area ratio of the light field and the dark field is measured for a change in light and dark fields under Cross-Nicol polarized light. In the X-ray small angle scattering measurement, a ratio of peak intensity corresponding to a specific lattice spacing obtained by irradiating X-ray in every direction to a sample is measured. In the present invention, the preferable orientation degree is 1.2 or more of the ratio of (a ratio of light field area)/(a ratio of dark field area) under a state in which the light field is largest in measurement under a cross-Nicol polarized light of with a polarizing microscope, preferably 1.5 or more. When the orientation degree is measured by using an X-ray small angle scattering measurement apparatus, the peak intensity ratio corresponding to a specific lattice spacing represented by the ratio of (the peak intensity in an irradiation direction of the strongest peak intensity)/(the peak intensity in an irradiation direction of the weakest peak intensity) is 1.2 or more, preferably 2.0 or more.

In the present invention, the method of measuring the ionic conductivity of the ionic conduction structural member, a method of measurement based on a resistance of a portion of a constant volume of the ionic conduction structural member can be mentioned. Concretely, as shown in FIG. 7, the ionic conduction structural member 701 is sandwiched by two electrode plates 702 connected to an impedance measuring device 703 and a resistance value r of the ionic conduction structural member 701 between the both electrodes 702 was measured by the impedance measuring device 703, while the thickness d and area A of the ionic conduction structural member 701 is measured, and the ionic conductivity is calculated using the equation of Ionic Conductivity σ=d/(A×r). As another method, gap electrodes having an electrode length L are brought into close contact with the ionic conduction structural member with an electrode distance w, and the resistance value r between the electrodes is measured by using the impedance measuring device while the thickness d of the ionic conduction structural member is measured, then the ionic conductivity is calculated using the equation of Ionic Conductivity σ=w/(L×d×r).

The polymer matrix constituting the skeleton of the ionic conduction structural member of the present invention is comprised of the polymer chain having the crosslinked structure constituted of the segment having side chains containing the polyethylene oxide group and the polypropylene oxide group and the segment having the side chains having the ethylene oxide group(s).

Examples of methods for analyzing the polymer matrix composition constituting the skeleton and chemical structure of the ionic conduction structural member are: a method of analyzing bonding and compositions of atomic groups using an infrared absorption spectrometer or visible ultraviolet absorption spectrometer: a method of analyzing bonding, compositions of atomic groups and structure using a nuclear magnetic resonance spectrometer, electron spin resonance spectrometer or optical rotatory dispersion system; a method of analyzing compositions of atomic groups using a mass spectrometer; a method of measuring compositions of atomic groups and structure such as polymerization degree using various chromatography such as liquid chromatography and gas chromatography; and a method of identifying and quantitating by direct titration of functional group. In the analysis, samples to be measured are treated directly or treated with chemical decomposition depending on the measurement methods.

Examples of the segment having side chains containing polyethylene oxide group and polypropylene oxide group constructing a part of the polymer skeleton are repeated units of the structure having groups containing polyethylene oxide group and polypropylene oxide group in the side chain part bonded to the main chain and having at least one side chain comprising a group containing polyethylene oxide group and polypropylene oxide group. The polymer may optionally have a side chain not containing the group containing the polyethylene oxide group and polypropylene oxide group.

Examples of the segment having a side chain containing an ethylene oxide group which forms a part of the polymer skeleton are repeated units of the structure containing ethylene oxide group in the side chain part bonded to the main chain, and have at least one of the side chain comprising the group containing ethylene oxide group. The polymer may optionally have a side chain free from the group containing ethylene oxide group.

The manner of repetition in each segment is not always necessary to be the same form of repetition, and encompasses the state in which the repeated units are not continuous, for example, a state in which the direction of the repeated unit is reversed or a state in which a segment of a different structure is inserted between repeated units of the same structure.

Example of the segment having the side chain containing polyethylene oxide group and polypropylene oxide group of the present invention may optionally contain other functional group(s) in the side chain part as long as the segment has the structure represented by the following general formula (1).

The content of the segment having the structure represented by the following general formula (1) in the polymer matrix constructing the ionic conduction structural member of the present invention is 1% or more in terms of the percentage of the number of the segments on the basis of the number of whole segments, preferably 2% or more, and more-preferably 10% or more.

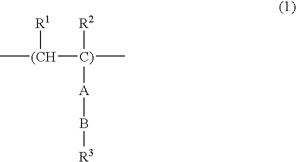

In the general formula (1), R¹ and R² are independently H or an alkyl group of 2 or less carbon atoms, and are preferably H or methyl group since the orientation property of the polymer matrix is improved. Further, R³ is an alkyl group of 4 or less carbon atoms, and are preferably methyl group or ethyl group since the affinity of the polymer matrix with the solvent is improved.

Either one of A and B is a group having at least polyethylene oxide group —(CH₂—CH₂—O)ₘ, and the other one is a group having at least polypropylene oxide group —(CH₂—CH(CH₃)—O)ₙ—, and each group forms a block. Further, each of A and B may optionally contain a functional group such as —CO—, —COO—, —OCOO—, —CONH—, —CONR—, —OCONH—, —NH—, —NR—, —SO— and —SO₂—, wherein R is an alkyl group.

The expression “the polyethylene oxide group and the polypropylene oxide group each form a block” employed herein is intended to mean such a structure that both a portion having ethylene oxides repeated successively and a portion having propylene oxides repeated successively are present. Namely, the structure of —(CH₂—CH₂—O)₄—(CH₂—CH(CH₃)—O)₅— means that a structure having —CH₂—CH(CH₃)—O— repeated five times successively is bonded to a structure having —CH₂—CH₂—O— repeated four times successively. m and n may independently be an integer of 3 or more, and from the viewpoint of formation of ionic conduction paths, it is preferable that m and n are independently an integer within the range of 5 to 100, and more preferable that m and n are independently an integer within the range of 10 to 50.

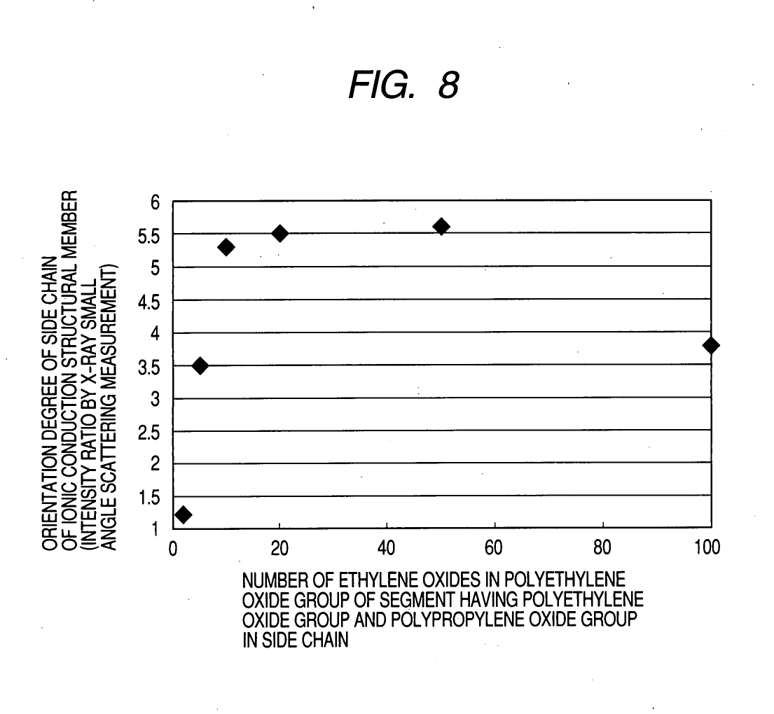

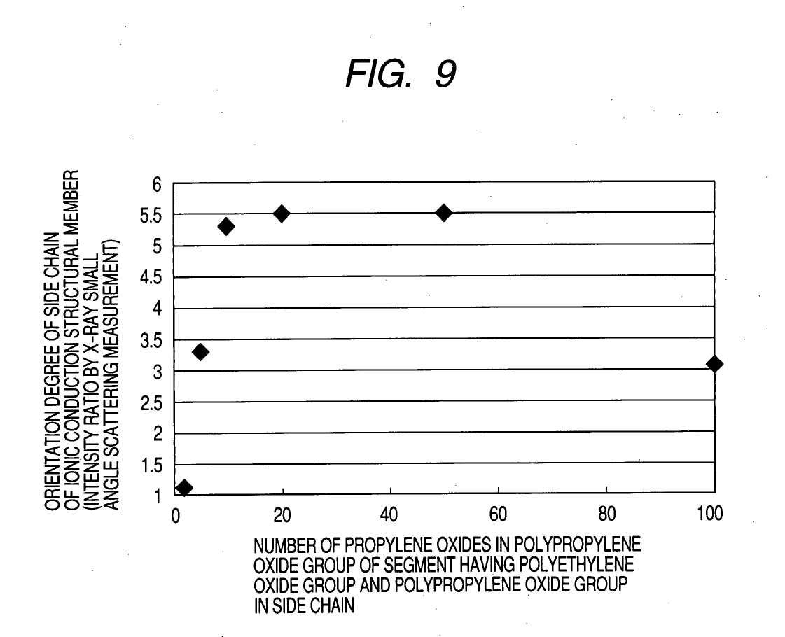

As is clearly seen from FIG. 8 which shows the relationship between the number m of polyethylene oxide group —(CH₂—CH₂—O)ₘ— and the orientation degree of the side chain of the polymer matrix and FIG. 9 which shows the relationship between the number n of polypropylene oxide group —(CH₂—CH(CH₃)—O)ₙ— and the orientation degree of the side chain of the polymer matrix, when m or n is 2 or less, orientation property is hardly provided and a high ionic conductivity can not be achieved. On the other hand, if the numbers m and n are increased, the content of the polyethylene oxide group and polypropylene oxide group in the polymer matrix may excessively be increased to cause a lowering in the mechanical strength.

The segment having the side chain containing ethylene oxide group of the present invention has the structure represented by the following general formula (2) and may optionally further contain other functional groups in the side chain part.

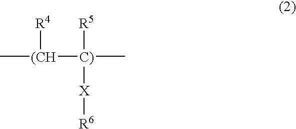

In the general formula (2), R⁴ and R⁵ are independently H or an alkyl group of 2 or less carbon atoms, and are preferably H or methyl group since the orientation property of the polymer matrix is improved. Further, R⁶ is an alkyl group of 4 or less carbon atoms, and are preferably methyl group or ethyl group since the affinity of the polymer matrix with the solvent is improved.

X is a group having at least ethylene oxide group —(CH₂—CH₂—O)ₖ— and may optionally further contain a functional group such as —CO—, —COO—, —OCOO—, —CONH—,—CONR—, —OCONH—, —NH—, —NR—, —SO— and —SO₂—, wherein R is an alkyl group. k is an integer of 1 or more, and is preferably an integer of 2 to 100 from the viewpoint of the affinity with the solvent, more preferably an integer within the range of 3 to 30. When k is 0, i.e. when no ethylene oxide group is contained, the affinity with the solvent is low and the content of the solvent in the ionic conduction structural member is difficult to increase.

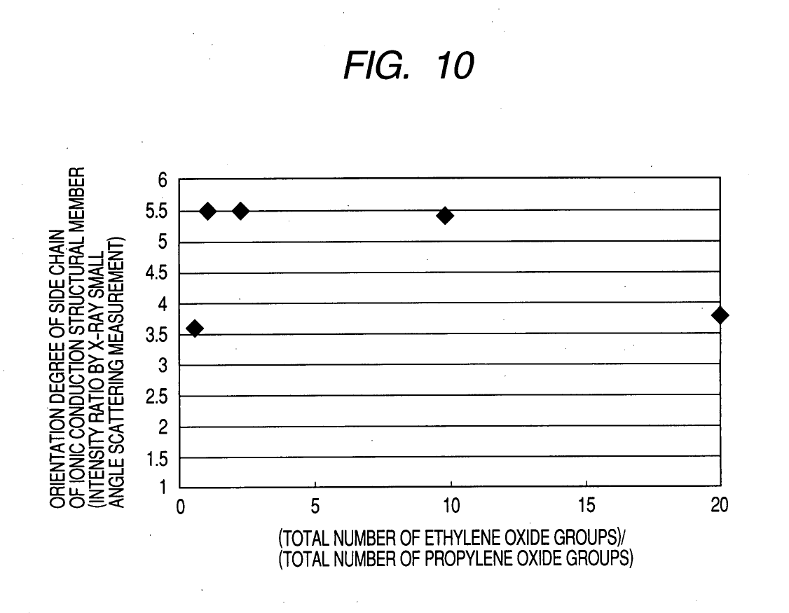

Further, if the ratio of —CH₂—CH₂—O— group and —CH₂—CH(CH₃)—O— group contained in the polymer matrix is within the range of (the total number of —CH₂—CH₂—O— groups in the entire polymer matrix)/(the total number of —CH₂—CH(CH₃)—O— groups in the entire polymer matrix)=0.5 to 20, preferably within the range of 1.0 to 10, the orientation property of the polymer matrix is improved and oriented ionic conduction paths are stably formed even in a state in which the content of the solvent is high (a state in which the content of the polymer matrix in the ionic conduction structural member is low), which is preferred. FIG. 10 is a view showing the relationship between the ratio of (the total number of —CH₂—CH₂—O— groups in the entire polymer matrix)/(the total number of —CH₂—CH(CH₃)—O— groups in the entire polymer matrix) and the orientation degree of the side chain of the general formula (1). The reason is that as is clearly seen from FIG. 10, the balance between hydrophilicity and the hydrophobicity effective for development of the orientation property can be maintained by the total polyethylene oxide group and polypropylene oxide group contained in the polymer matrix skeleton, and even in case of a low content of the polymer matrix and a high content of the solvent in the ionic conduction structural member, the orientation property can be improved by the entire polymer matrix skeleton. Incidentally, as to the total number of —CH₂—CH₂—O— groups and the total number of —CH₂—CH(CH₃)—O— groups, if —CH₂—CH₂—O— groups or —CH₂—CH(CH₃)—O— groups are contained in a part of the polymer matrix other than the segments of the general formula (1) and the general formula (2), the numbers of such foreign —CH₂—CH₂—O— groups and —CH₂—CH(CH₃)—O— groups are also included in the total numbers.

With regard to the crosslinked structure of the polymer chain constructing the polymer skeleton, although the physical bonding such as the hydrogen bonding and the ionic bonding made by forming ion pairs and the chemical bonding such as covalent bonding can be mentioned, since the physical bonding such as hydrogen bonding may be severed by a temperature change or pH change to change the bonding state, it is preferred that the crosslinked structure is formed by covalent bonding as the chemical bonding that is less sensitive to such changes. Among them, if the crosslinked structure of the polymer chain is the structure crosslinked with the segment represented by the following general formula (5), the segments represented by the general formula (1) and the general formula (2) are liable to form a stable structure, which is preferred.

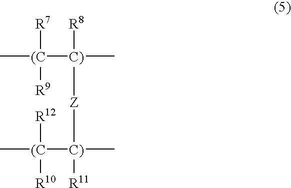

In the general formula (5), R⁷, R⁸, R⁹, R¹⁰, R¹¹, and R¹² are independently H or an alkyl group, are preferably H or methyl group. Z is a group that forms crosslinkage and is not specifically limited as long as the both ends thereof can form a bond, respectively as shown in the general formula (5), and is preferably a group having at least one bonding or functional group selected from the group consisting of —CO—, —COO—, —OCOO—, —CONH—, —CONR— wherein R is an alkyl group, —OCONH—, —NH—, —NR— wherein R is an alkyl group, —SO—, —SO₂—, and ether group, more preferably a group having 2 or more ether group, i.e. polyether group.

The polymer matrix of the ionic conduction structural member of the present invention is constructed by the above segment, and one having the structure represented by the general formula (6) is preferable, since ionic conduction paths are formed stably and the mechanical strength is considerably high.

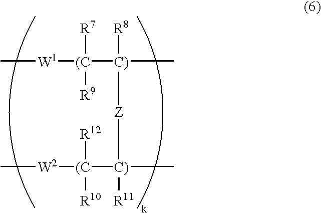

In the general formula (6), W¹ and W² are defined as follows. When the above general formula (1) is designated as A and the above general formula (2) is designated as B, W¹ is represented by A_{m′} and W² is represented by Bₙ or W¹ and W² are independently one selected from the group consisting of A_{m′}B_{n′}, A_{k′}B_{m′}A_{n′}, B_{k′}A_{m′}B_{n′}, (AB)_{n′}, (ABA)_{n′}, and (BAB)_{n′}. Incidentally, A_{m′}, B_{n′}, (AB)_{n′}, and the like employed herein are intended to mean the repetition of A, B and (AB), namely A_{m′} means a structure having A repeated m′ times; B_{n′} means a structure having B repeated n′ times; and (AB)_{n′} means a structure having (AB) repeated n′ times. In the polymer matrix constituting the ionic conduction structural member of the present invention, if the ratio of contents of the segment of the general formula (5), i.e. (the number of segments of the general formula (1)+the number of segments of the general formula (2))/(the number of segments of the general formula (5)) is 0.1 to 40, and is preferably 1 to 30 since ionic conductive paths are formed stably and the mechanical strength is improved.

In the general formula (6), R⁷, R⁸, R⁹, R¹⁰, R¹¹, and R¹² and Z are as defined for the general formula (5), and k′, m′ and n′ are independently an integer of 1 or more. Further, the general formula (6) does not always mean to form constant repeated units throughout the polymer as is the case with a general formula representing an ordinary copolymer, but indicates the repeated unit in a state in which the polymer is averaged throughout the structure thereof.

The above is the explanation of the structure of the ionic conduction structural member of the present invention.

The glass transition temperature of the ionic conduction structural member of the present invention is preferably within the range from −20° C. to −120° C., more preferably within the range from −30° C. to −100° C., most preferably within the range from −50° C. to −100° C. The glass transition temperature is the transition temperature showing the phenomenon of structural change peculiar to a polymer, i.e. relaxation temperature of the thermal motion of the polymer main chain. The polymer is generally changed depending on increased temperature of the polymer from the glassy hard structure without generating the thermal motion of the polymer main chain to the rubbery state having some degree of freedom as a result of relaxation of the thermal motion of the polymer main chain, further the polymer main chain is changed to the liquid having complete degree of freedom. Namely, the temperature accompanied by the structural change from the glassy state to the rubbery state is the glass transition temperature. Since the thermal motion of the polymer chain is generated somewhat actively as a result of the structural change from the glassy state to the rubbery state, diffusion of ions in the ionic conduction structural member occurs easily to improve the ionic conductivity. If the glass transition temperature of the ionic conduction structural member is higher than −20° C., since decrease in the thermal motion of the polymer matrix, which constitutes the ionic conduction structural member, occurs easily at a low temperature and the diffusibility of ions is easily lowered, there is a possibility to lower the ionic conductivity at a low temperature. If the glass transition temperature of the ionic conduction structural member is lower than −120° C., the degree of softening of the polymer easily becomes greater at a high temperature and the mechanical strength may be lowered.

The control of the glass transition temperature of the ionic conduction structural member can be performed by controlling the glass transition temperature of the polymer matrix itself constituting the ionic conduction structural member or adjusting the content of the solvent in the ionic conduction structural member. Further, the glass transition temperature of the polymer matrix itself can be controlled by forming the polymer matrix using a polymer having a low grass transition temperature, or can be controlled by adjusting the crosslinking density of the polymer matrix having the crosslinked structure of the present invention. The glass transition temperature can also be measured by a thermal analysis in the compression loading method using a thermomechanical analyzer or measurement using a differential scanning calorimeter.

The method of measuring the mechanical strength of the ionic conduction structural member includes a method of expressing the strength using a Young's modulus that is calculated from the rate of distortion when applied with a weight such as pressure application and pulling. The mechanical strength is preferably Young's modulus 1×10⁵ pascal (Pa) or more, more preferably 2×10⁵ pascal (Pa) or more. If this mechanical strength is a tensile strength, in case that the ionic conduction structural member in the form of a thin film is used for the secondary battery, it is more preferable in the battery assembled with rolled electrodes.

Examples of the electrolytes of the ionic conduction structural member of the present invention include a salt consisting of cation such as lithium ion, sodium ion, potassium ion, tetraalkylammonium ion, etc. and Lewis acid ion (BF₄⁻, PF₆⁻, AsF₆⁻, ClO₄⁻, CF₃SO₃⁻, (CF₃SO₂₎₂N⁻, (CF₃SO₂₎₃C⁻, BPh₄⁻ (Ph: phenyl group)), alkali metal hydroxide such as lithium hydroxide, sodium hydroxide, potassium hydroxide, etc. and mixture thereof. Among them, at least one selected from lithium salts is preferable.

The solvent used in the present invention includes those solvents which function as a plasticizer, namely it is not the state of a solvent adsorbed in a sponge but a solvent which can plasticize the polymer matrix, which constitutes the ionic conduction structural member of the present invention, into a gelatinous state and has affinity with the polymer matrix. Further, it is preferable that the solvent can dissolve the above electrolyte, from the viewpoint of improving the diffusibility of ions. The content of the solvent in the ionic conduction structural member is preferably 70 to 99% by weight, more preferably 80 to 99% by weight. Further, it is more preferable that the above-mentioned content of the solvent is in terms of the content in a state in which the polymer matrix contains the solvent in the saturated state.

In addition, the content of the electrolyte in the solvent is preferably 0.5 to 3 mol/dm³ in terms of the electrolyte concentration in the solvent, more preferably 1 to 2.5 mol/dm³, because the concentration polarization of the electrolytic ions is difficult to occur when flowing a large current and the lowering in the ionic conductivity can be suppressed.

In order to form an ionic conduction structural member having the ratio of the polymer matrix to the solvent as mentioned above, it is necessary to consider the combination of the polymer matrix and the solvent. If the solvent having a solubility parameter of preferably 15.0 to 30.0 (J/cm³)^{1/2}, more preferably 17.0 to 30.0 (J/cm³)^{1/2}, is selected, good solubility of the supporting electrolyte can be obtained. When the solvent having a solubility parameter of 14.0 to 28.0 (J/cm³)^{1/2} in the entire polymer chain is selected, the polymer matrix can preferably be obtained, since the solvent can be contained stably in the polymer matrix and the lowering in the mechanical strength is small. If there is a large difference in the solubility parameter between the solvent and the polymer matrix, the affinity between the solvent and the polymer matrix is lowered, but if the difference in the solubility parameters becomes small, the polymer matrix can contain the solvent stably, and it is more preferable since the leakage of the solvent in a pressurized state is reduced and the stability is improved.

The solubility parameter (δ((J/cm³)^{1/2})) is expressed as a square root of cohesive energy density of a solvent, and is a value characteristic to the solvent indicating the solubility of the solvent calculated from the equation δ=(Δhvap/V⁰)^{1/2}, wherein Ahvap is the molar heat of vaporization of the solvent and V⁰ is the molar volume of the solvent, for example δ=42 for water; δ=22.4 for ethanol and δ=14.6 for hexane. Further, the solubility parameter of a polymer (ä) is a value experimentally calculated with the solubility parameter of a solvent providing an infinite solubility or maximum swelling of a polymer being defined as the solubility parameter of the polymer, or a value calculated from the molecular cohesive energy of the functional group of the polymer. The solubility parameter of the polymer used in the present invention is a value calculated from the molecular cohesive energy of the functional group of the polymer. A method of calculating the solubility parameter (δ) from the molecular cohesive energy of the functional group of the polymer is a method of calculating it using the equation δ=ρΣF/M, wherein ρ is the density of a polymer (g/cm³), F is the total sum ((J/cm³)^{1/2}/mol) of molecular cohesive energy constants of a monomer unit and M is the molecular weight of the monomer unit (g/mol). Incidentally, the total sum F of the molecular cohesive energy constants of the monomer unit was calculated by using values of Hoy described in “Solvent Handbook” Ed. Kodansha Scientific or “Polymer Handbook”, 3rd. Ed., WILEY INTERSCIENCE.

Examples of such solvents are aprotic polar solvents, preferably, ethers, carbonates, nitrites, amides, esters, nitro compounds, sulfur compounds and halides. A single solvent or a mixture of two or more solvents selected from the group consisting of these solvents can be used. Preferable examples are acetonitrile, benzonitrile, propylene carbonate, ethylene carbonate, dimethyl carbonate, diethyl carbonate, ethyl methyl carbonate, dimethylformamide, tetrahydrofuran, nitrobenzene, dichloroethane, diethoxyethane, 1,2-dimethoxyethane, chlorobenzene, -butyrolactone, dioxolane, sulfolane, nitromethane, dimethyl sulfide, dimethyl sulfoxide, dimethoxyethane, methyl formate, 3-methyl-2-oxazolidinone, 2-methyltetrahydrofuran, sulfur dioxide, phosphoryl chloride, thionyl chloride, sulfuryl chloride and a mixture thereof. Among these solvents, the solvent having a boiling point 70° C. or more is preferable, since evaporation of the solvent during production of the ionic conduction structural member can be suppressed and the deterioration during storage at a high temperature can be suppressed. The solvent having a freezing point of −20° C. or less is preferable, since such a solvent in the ionic conduction structural member is difficult to freeze at a low temperature and the ionic conductivity is difficult to decrease.

The shape of the ionic conduction structural member of the present invention can be selected freely depending on usage and the shape of the polymer matrix constituting the ionic conduction structural member is not limited. For example, the ionic conduction structural member used in the form of a film in the secondary battery includes one consisting of a film-shaped polymer matrix, one prepared by processing a particulate polymer matrix into a film shape using a binder; and one consisting of a polymer matrix prepared by forming a particulate polymer matrix into a film shape by heat pressing. The ionic conduction structural member may optionally contain at least one support selected from the group consisting of another resin powder, glass powder, ceramic powder, nonwoven fabric and a porous film. It is preferable that the resin powder, glass powder or ceramic powder is particulate, since the support can be contained uniformly in the ionic conduction structural member. The content of the support in the ionic conduction structural member is preferably 1 to 50% by weight, more preferably 1 to 40% by weight from the viewpoint of securing the ionic conductivity.

The method of producing an ionic conduction structural member of the present invention will be explained hereinbelow.

The ionic conduction structural member of the present invention can be produced by performing in sequence at least the (a) of mixing a monomer having a polyethylene oxide group and a polypropylene oxide group represented by the following general formula (3), a monomer having an ethylene oxide group represented by the following general formula (4), a solvent and an electrolyte, and the step (b) of preparing a polymer matrix by subjecting the mixture obtained by the step (a) to a polymerization reaction. 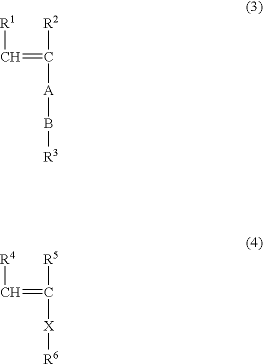
wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ, and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more.

The reasons why the desired ionic conduction structural member can be prepared by performing the step (a) and the step (b) successively may be as follows. When the polymerization reaction is performed in a state containing the monomer having side chain containing the polyethylene oxide group and the polypropylene oxide group, the polyethylene oxide group and the polypropylene oxide group, which are blocked respectively, repulse each other during the polymerization reaction, and further association of polypropylene oxide groups occurs to form a state in which the polypropylene oxide groups are oriented as is the case with the formation of the orientation structure in a layered fashion by a surfactant having hydrophobic and hydrophilic groups. As a result of the formation of the orientation state by the side chain parts having polypropylene oxide group, the main chain itself will also have an orientation property, so that the entire polymer forms an orientation structure. Since the polymerization reaction proceeds while maintaining the orientation structure, the structure having the orientation property is formed in the entire polymer skeleton, whereby the ionic conduction structural member having the polymer matrix in which the main chain part and the side chain part of the polymer chain are oriented respectively can be formed.

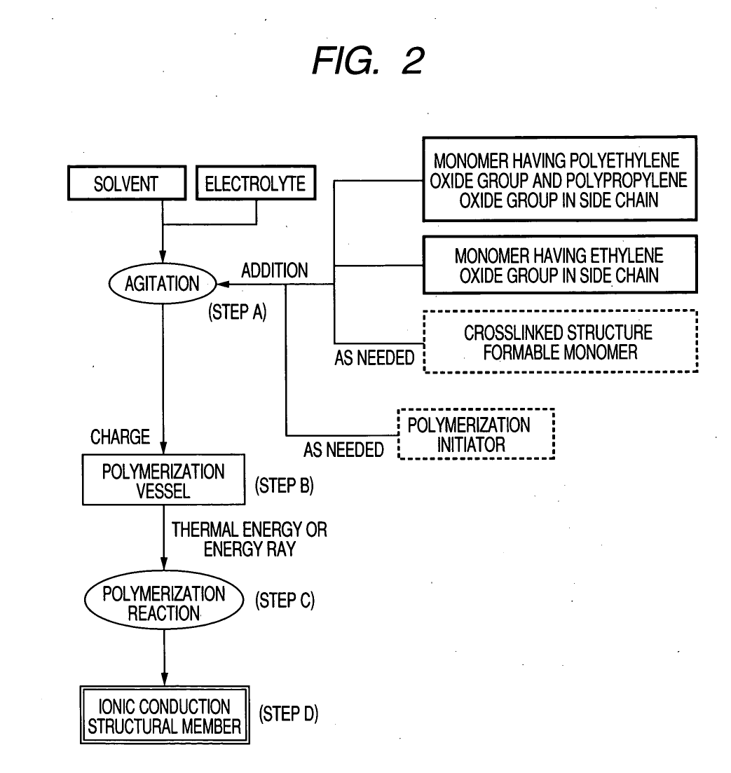

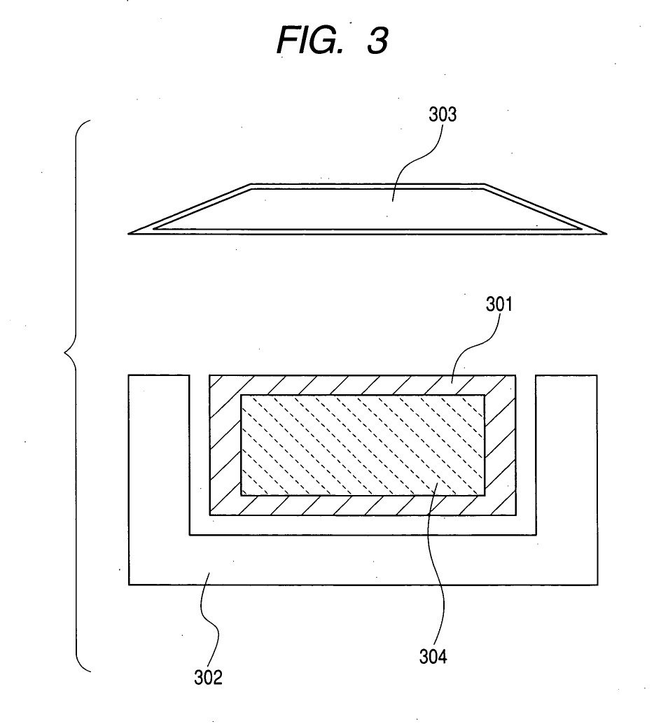

The method of producing the ionic conduction structural member of the present invention is basically performed by mixing a monomer having a side chain containing a polyethylene oxide group and a polypropylene oxide group, a monomer having an ethylene oxide group, a predetermined solvent and a predetermined electrolyte and subjecting the thus obtained mixture to a polymerization reaction. Preferable embodiments of the method of production of the ionic conduction structural member of the present invention are explained with reference to FIGS. 2 and 3 below.

FIG. 2 illustrates the flow chart of an embodiment of the production method of the present invention, and FIG. 3 illustrates a preferable example of a production apparatus used in the production method of the present invention. In FIG. 3, reference numeral 301 denotes a polymerization vessel, 302 denotes a temperature-controlling device, 303 denotes an energy ray irradiation device, and 304 denotes a mixture.

The first monomer having side chain containing polyethylene oxide group and polypropylene oxide group according to the general formula (1), the second monomer having ethylene oxide group, a predetermined solvent and a predetermined electrolyte are mixed, and a third monomer which can construct the crosslinked structure and a polymerization initiator are further added as needed, and mixed sufficiently until a homogeneous mixture system can be obtained (Step A). The thus obtained mixture 304 is charged into the polymerization vessel 301 shown in FIG. 3 (Step B), and an energy such as heat or an optical energy ray is applied to the vessel by using the temperature-controlling device 302 or the energy ray irradiation device 303 shown in FIG. 3 to perform a polymerization reaction (Step C). The polymerized product generated in the polymerization vessel 301 is taken out from the vessel to provide an ionic conduction structural member (Step D).

The addition amounts of the monomers are preferably such that the mixing ratio of the first monomer and the second monomer, i.e. the molar number of the first monomer/the molar number of the second monomer=0.01 to 1, preferably 0.02 to 0.5, to provide preferable affinity between the polymer matrix and the solvent. When the third monomer is added and mixed such that (the molar number of the first monomer+the molar number of the second monomer)/the molar number of the third monomer=0.1 to 40, preferably 1 to 30, ionic conduction paths can be formed stably and a good mechanical strength can be obtained.

In case of adding a large amount of the solvent, when the mixing ratio of the first monomer and the second monomer is set so as to satisfy the ratio, i.e. the total number of —CH₂—CH₂—O— groups contained in the polymer matrix obtained after the polymerization/the total number of —CH₂—CH(CH₃)—O— groups contained in the polymer matrix obtained after the polymerization=0.5 to 20, more preferably 1.0 to 10, ionic conduction paths can be stably formed even under a condition such that the polymer matrix is formed in a coarse state due to the existence of the large amount of solvent. In case that a monomer containing —CH₂—CH₂—O— group and —CH₂—CH(CH₃)—O— group other than the first monomer and the second monomer, e.g. the third monomer containing —CH₂—CH₂—O— group and —CH₂—CH(CH₃)—O— group, is to be used, the mixing ratio is determined by considering the total number of groups including the number groups contained in such a monomer.

The solvent is added in a content preferably within the range of 70 to 99% by weight, more preferably 80 to 99% by weight on the basis of the total weight of the monomers, the electrolyte and the solvent.

When the polymerization reaction is performed (Step C), the polymerization reaction is preferably performed under a sealed system except for the case accompanied by generation of a gas, since a change in composition due to evaporation of the solvent and monomers can be suppressed. If necessary, it is preferable to perform the polymerization reaction with stirring using ultrasonic dispersion for preventing separation of the system due to deposition of the material monomers and to perform the polymerization reaction under heating at a constant temperature. Further, when the polymerization reaction is performed, for improving the orientation property of the polymer skeleton, a method of performing the polymerization reaction under application of a magnetic field or electric field or a method of performing the polymerization reaction in contact with a substrate subjected to a surface treatment such as rubbing or hydrophobic treatment is preferably used. The method of effecting the polymerization reaction while bringing the mixture into contact with the substrate having hydrophobicity is preferable, since ionic conduction paths can easily be formed. The substrate having hydrophobicity has a contact angle with water of preferably 20° or more, more preferably 50° or more. Further, it is more preferable that the entire substrate has a uniform contact angle with water, since ionic conduction paths can be formed uniformly.

The substrate can be used in the form of particle, plate, cylinder, etc. When the plate substrate is used, the direction of the ionic conduction path can be preferably controlled stably and uniformly, which is preferred. Examples of the substrate having such hydrophobicity which can be used are: a substrate of a fluororesin such as tetrafluoroethylene, polyvinylidene fluoride and a copolymer of vinylidene fluoride and hexafluoropropylene, and hydrophobic resin such as polyethylene and polypropylene; a substrate having a fluororesin film such as tetrafluoroethylene, polyvinylidene fluoride and a copolymer of vinylidene fluoride and hexafluoropropylene, a polyethylene film or polypropylene film adhered to a substrate of glass or metal; a substrate prepared by coating a fluororesin such as tetrafluoroethylene, polyvinylidene fluoride and a copolymer of vinylidene fluoride and hexafluoropropylene, polyethylene or polypropylene to a sheet of glass or metal; and a substrate in which hydroxyl groups of a glass substrate is chemically substituted with hydrophobic groups using a silylating agent. When the ionic conduction structural member of the present invention is provided between a negative electrode and a positive electrode of a secondary battery, the substrate may be an electrode structure prepared by impregnation with a fluororesin such as tetrafluoroethylene, polyvinylidene fluoride and a copolymer of vinylidene fluoride and hexafluoropropylene, polyethylene or polypropylene.

The method of attaining contact with a substrate having hydrophobicity preferably comprises using a polymerization vessel constituted of a substrate at least one surface of which has hydrophobicity. In case of preparing a film-shaped polymer, if the polymerization is performed under the condition such that a broadest surface of the obtained film is in contact with the substrate, the ionic conduction path is liable to be formed in the film thickness direction, which is preferable. It is more preferable that the polymerization is performed under the condition such that the both sides of the broadest surface of the film are in contact with the substrate.

As the polymerization method, a method suitable to the monomer used is selected. A polymerization reaction using a thermal energy or ultraviolet ray is preferable due to its easy controllability. Further, it is preferred that the polymerization is a radical polymerization since the reaction can be performed under a mild polymerization condition. When the radical polymerization is performed under ultraviolet irradiation, it is preferable that the temperature of the polymerization solution is maintained constantly by heating or cooling, since the polymerization can be performed stably by reducing the temperature change caused by reaction heat and infrared ray from an irradiation source.

If a step for forming a crosslinked structure is performed in addition to the step of performing the polymerization mentioned above, the ionic conduction path of the ionic conduction structural member becomes more stable while improving the mechanical strength, which is preferred. Examples of the step of forming the crosslinked structure include a method of forming a crosslinked structure after polymerization or a method of forming a crosslinked structure simultaneously with the polymerization reaction. The method of forming the crosslinked structure after the polymerization reaction includes a method that is available depending on the monomer capable of forming the crosslinked structure. For example, a method of performing a crosslinking reaction for generating radicals by adding a radical initiator to the polymer, or by irradiation with UV, electron beam, gamma ray, heat ray or plasma, and a method of generating a crosslinking reaction by reacting active groups in a part of the polymer chain with a crosslinking agent can be mentioned. With regard to the method of forming the crosslinked structure simultaneously with the polymerization reaction, if the polymerization is performed by adding the third monomer, which can form a crosslinked structure by the polymerization, into the monomer mixture, ionic conduction paths of the ionic conduction structural member can preferably be formed stably and uniformly. The thus obtained polymer matrix is preferably improved in the orientation property of the polymer skeleton by using a method of applying a magnetic field or electric field and a method of performing stretching. When performing such a treatment, heating the polymer matrix is preferable, since the orientation of the polymer skeleton can be improved.

In addition to the method of preparing the ionic conduction structural member by performing the polymerization reaction in the form suitable to the objective use, a method of using the ionic conduction structural member by cutting in a desired forms, a method of using the ionic conduction structural member after crushing and powdering and then molding into a desired form with a binder, and a method of processing the film form by heat-pressing a powdery polymer obtained by crushing the ionic conduction structural member can be mentioned.

In addition to the above steps, it is preferable to perform the process in which the support is incorporated into the ionic conduction structural member. The step for incorporating the support includes a method wherein, when putting the mixed solution into the polymerization vessel 301 (Step B), the support is also put in the vessel and the polymerization is performed including the support, and a method of crushing the ionic conduction structural member or polymer matrix into particles and mixing with the support or incorporating into the support. The support may preferably be at least one selected from the group consisting of resin powder, glass powder, ceramic powder, nonwoven fabric and a porous film. The content of the support is preferably 1 to 50% by weight, more preferably 1 to 40% by weight, since the mechanical strength of the entire ionic conduction structural member is improved and ionic conduction paths traveling along the interface between the support and the ionic conductor are formed to a suitable degree, and as a result, the volume occupied by the ionic conductor is hardly reduced, which is preferred. In order to improve the affinity and adhesion between the support and the ionic conductor, performing a surface treatment of the support using corona discharge or plasma is preferable.

The materials used in the method of producing an ionic conduction structural member of the present invention will be explained hereinbelow.

(Monomer Having Side Chain Containing Polyethylene Oxide Group and Polypropylene Oxide Group: First Monomer)

The monomer having a side chain containing polyethylene oxide group and polypropylene oxide group may optionally contain other functional group as long as the monomer has the structure represented by the following general formula (3).

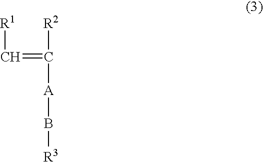

In the general formula (3), R¹ and R² are independently H or an alkyl group of 2 or less carbon atoms, and are preferably H or methyl group, since the orientation property of the polymer matrix is improved. R³ is an alkyl group of 4 or less carbon atoms, and is preferably methyl group or ethyl group since the affinity between the polymer matrix and the solvent is improved.

In A and B in the general formula (3), either one is a group having at least polyethylene oxide group —(CH₂—CH₂—O)ₘ—, and the other one is a group having at least polypropylene oxide group —(CH₂—CH(CH₃)—O)ₙ—, and each group forms a block. In addition, A and B each may optionally further contain a functional group such as —CO—, —COO—, —OCOO—, —CONH—, —CONR—, —OCONH—, —NH—, —NR—, —SO— and —SO₂—, wherein R is alkyl group. The expression “the polyethylene oxide group and the polypropylene oxide group each form a block” employed herein is intended to mean such a structure that both a portion having ethylene oxides repeated successively and a portion having propylene oxides repeated successively are present. Namely, the structure of —(CH₂—CH₂—O)₄—(CH₂—CH(CH₃)—O)₅— means that a structure having —CH₂—CH(CH₃)—O— repeated five times successively is bonded to a structure having —CH₂—CH₂—O— repeated four times successively. m and n may independently be an integer of 3 or more, and from the viewpoint of formation of ionic conduction paths, it is preferable that m and n are independently an integer within the range of 5 to 100, and more preferable that m and n are independently an integer within the range of 10 to 50.

Preferable examples of the monomer represented by the general formula (3) (the first monomer) include methoxy-decaethyleneoxy-block-decapropyleneoxy-acrylate (the number of ethylene oxide: 10, the number of propylene oxide: 10); ethoxy-eicosaethyleneoxy-block-eicosapropyleneoxy-acrylate (the number of ethylene oxide: 20, the number of propylene oxide: 20); methoxy-triacontaethyleneoxy-block-triacontapropyleneoxy-methacrylate (the number of ethylene oxide: 30, the number of propylene oxide: 30); methoxy-eicosapropyleneoxy-block-eicosaethyleneoxy-acrylate (the number of propylene oxide: 20, the number of ethylene oxide: 20); ethoxy-triacontapropyleneoxy-block-decaethyleneoxy-acrylate (the number of propylene oxide: 30, the number of ethylene oxide: 10); n-butoxy-decapropyleneoxy-block-pentacontaethyleneoxy-methacrylate (the number of propylene oxide: 10, the number of ethylene oxide: 50); n-propoxy-pentaethyleneoxy-block-pentadecapropyleneoxy-acrylate (the number of ethylene oxide: 5, the number of propylene oxide: 15); and methoxy-triacontapropyleneoxy-block-nonacontaethyleneoxy-methacrylate (the number of propylene oxide: 30, the number of ethylene oxide: 90).

(Monomer Having Ethylene Oxide Group: Second Monomer)

The monomer having a side chain containing ethylene oxide group used in the present invention may optionally contain other functional group as long as the monomer has the structure represented by the following general formula (4):

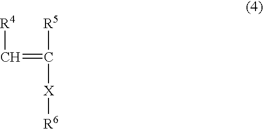

In the general formula (4), R⁴ and R⁵ are independently H or an alkyl group of 2 or less carbon atoms, and are preferably H or methyl group since the orientation property of the polymer matrix is improved. R⁶ is an alkyl group of 4 or less carbon atoms, and is preferably methyl group or ethyl group since the affinity between the polymer matrix and the solvent is improved.

X in the general formula (4) is a group having at least ethylene oxide group —(CH₂—CH₂—O)ₖ—, and may optionally further contain another functional group such as —CO—, —COO—, —OCOO—, —CONH—,—CONR—, —OCONH—, —NH—, —NR—, —SO— and —SO₂—, wherein R is alkyl group. Especially, if it contains a group having a plurality of ethylene oxide groups —(CH₂—CH₂—O)ₖ—, the affinity with the solvent is improved and preferred. The value of k is preferably an integer of 2 to 100, more preferably within the range of 3 to 30 since it is possible to increase the content of the solvent without decreasing the strength of the formed ionic conduction structural member. When k is 0, i.e. when no ethylene oxide group is contained, the affinity with the solvent is low and the content of the solvent in the ionic conduction structural member is difficult to increase.

Preferable examples of the monomer represented by the general formula (4) (the second monomer) include methoxy-triethyleneoxy-methacrylate (the number of ethylene oxide: 3); methoxy-tetraethyleneoxy-methacrylate (the number of ethylene oxide: 4); ethoxy-hexaethyleneoxy-methacrylate (the number of ethylene oxide: 6); n-butoxy-octaethyleneoxy-methacrylate (the number of ethylene oxide: 8); methoxy-eicosaethyleneoxy-methacrylate (the number of ethylene oxide: 20); ethoxy-tetraethyleneoxy-acrylate (the number of ethylene oxide: 4); methoxy-hexaethyleneoxy-acrylate (the number of ethylene oxide: 6); methoxy-octaethyleneoxy-acrylate (the number of ethylene oxide: 8); and ethoxy-eicosaethyleneoxy-acrylate (the number of ethylene oxide: 20).

(Crosslinked Structure Formable Monomer)

As the third monomer which can form a crosslinked structure, although a monomer forming the physical bonding such as the hydrogen bonding and the ionic bonding made by forming ion pairs and a monomer forming the chemical bonding such as covalent bonding can be mentioned, since the physical bonding such as hydrogen bonding may be severed by a temperature change or pH change to change the bonding state, it is preferred to use those monomers that form covalent bonds as the chemical bonding that is less sensitive to such changes. Further, as such monomers, a monomer having polymerizing functional groups that can polymerize with other 3 or more monomers is preferable, and a monomer having polymerizing functional groups that can polymerize with other 3 or more monomers only by the polymerization reaction (Step C) is more preferable. Examples of the polymerizing functional group of the monomer are a group that can form covalent bond such as ester linkage, amide linkage, ether linkage and urethane linkage by condensation polymerization, polycondensation or ring-opening polymerization and vinyl group that can perform addition polymerization. Among them, vinyl group or cyclic ether is preferable, and vinyl group or epoxide is more preferable, and vinyl group is most preferable. Especially, divinyl compound and trivinyl compound having 2 or more vinyl groups are preferable. Examples of vinyl group are vinyl group, allyl group, acryl group, methacryl group and croton group. Examples of epoxide are alkylene oxide such as ethylene oxide, propylene oxide and glycidyl ether.

Among them, the monomer forming the crosslinked structure is preferably the monomer represented by the general formula (7).

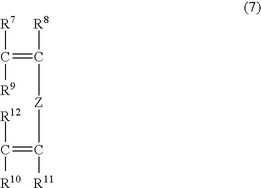

In the general formula (7), R⁷, R⁸, R⁹, R¹⁰, R¹¹, and R¹² are independently H or an alkyl group, are preferably H or methyl group. Z is a group that forms crosslinkage and is not specifically limited as long as the both ends thereof can form a bond, respectively as shown in the general formula (7), and is preferably a group having at least one bonding or functional group selected from the group consisting of —CO—, —COO—, —OCOO—, —CONH—, —CONR— wherein R is an alkyl group, —OCONH—, —NH—, —NR— wherein R is an alkyl group, —SO—, —SO₂—, and ether group, more preferably a group having 2 or more ether group, i.e. polyether group such as polyethylene oxide group and polypropylene oxide group.

Preferable examples of the monomer represented by the general formula (7) are: vinyl acrylate, ethylene glycol methacrylate, hexaethylene glycol dimethacrylate, hexaethylene glycol diacrylate, tridecaethylene glycol diacrylate, eicosaethylene glycol dimethacrylate, N,N′-methylene bisacrylamide, diethylene glycol dimethacrylate, diethylene glycol bisallylcarbonate, 1,4-butanediol diacrylate, pentadecanediol diacrylate, 1,10-decanediol dimethacrylate, neopentylglycol dimethacrylate, diallyl ether, diallyl sulfide, glyceryl dimethacrylate, 2-hydroxy-3-acryloyloxypropyl methacrylate, 2-methacroyloxyethyl acid phosphate, dimethyl-tricyclodecane diacrylate, hydroxypivalate neopentylglycol diacrylate, bisphenol A diacrylate and ethylene oxide addition diacrylate of bisphenol A.

(Solvent)

Examples of the solvent used in the step (a) of the production method of the present invention include a solvent that functions as a plasticizer for the ionic conduction structural member, and any solvent that does not inhibit the polymerization reaction can be used, even if the monomers and the electrolyte are not completely dissolved therein, but a solvent that can dissolve the monomers and the electrolyte is preferable. Further, a mixture of solvents that can dissolve only one of the monomers and electrolyte can also be preferably used. Further, a solvent which can dissolve the monomers and electrolyte and has a high affinity with the polymer matrix generated in the polymerization can form a uniform polymer matrix and is more preferable. Further, in case of removing the solvent in the subsequent steps, selecting a highly volatile solvent is preferable.

Examples of the solvent include methanol, ethanol, 1-propanol, 2-propanol, 1-butanol, ethylene glycol, glycerol, diethyl ether, diisopropyl ether, tetrahydrofuran, tetrahydropyran, 1,2-methoxyehtane, diethylene glycol dimethyl ether, acetone, ethyl methyl ketone, cyclohexanone, ethyl acetate, butyl acetate, propylene carbonate, ethylene carbonate, dimethyl carbonate, diethyl carbonate, ethyl methyl carbonate, formamide, N,N-dimethylformamide, N,N-dimethylacetamide, 1,3-dibutyl-2-imidazolidinone, N-methylpyrrolidone, acetonitrile, propionitrile, salicylonitrile, benzonitrile, ethylenediamine, triethyleneamine, aniline, pyridine, piperidine, morpholine, methylene chloride, chloroform, 1,2-dichloroethane, chlorobenzene, 1-bromo-2-chloroethane, nitromethane, nitrobenzene, o-nitrotoluene, diethoxyethane, 1,2-dimethoxyethane, a-butyrolactone, dioxolane, sulfolane, dimethyl sulfide, dimethyl sulfoxide, dimethoxyethane, methyl formate, 3-methyl-2-oxazoridinone, 2-methyltetrahydrofuran, sulfur dioxide, phosphoryl chloride, thionyl chloride and sulfuryl chloride. Incidentally, the solvent can be used alone or in combination of two or more.

When a solvent that cannot dissolve the monomers completely is used, a dispersing agent such as a surfactant may be added to the solvent. The addition amount of the dispersing agent at this time is 4% by weight or less, preferably 3% by weight or less, on the basis of the weight of the solvent. If more than 4% by weight of the dispersing agent is added, the orientation property in the formation of the ionic conduction path is liable to be lowered, and the amount of the remaining dispersing agent is large even after cleaning, so that the dispersing agent may easily inhibit the ionic conduction to lower the ionic conductivity.

(Polymerization Initiators)

As the polymerization initiator used in the present invention, a suitable polymerization initiator can be selected and used depending on the polymerization system such as polycondensation, addition polymerization and ring-opening polymerization, and the reaction mechanism such as radical polymerization, cationic polymerization and anionic polymerization. Examples of the polymerization initiator include an azo compound such as azobisisobutyronitrile, a peroxide such as benzoyl peroxide, a light absorbing/decomposing compound such as potassium persulfate, ammonium persulfate, a ketone compound and a metallocene compound, an acid such as H₂SO₄, H₃PO₄, HClO₄ and CCl₃CO₂H, a Friedel-Crafts catalyst such as BF₃, AlCl₃, TiCl₄ and SnCl₄, I₂, (C₆H₅)₃CCl, alkali metal and magnesium compound. The amount of the polymerization initiator to be added to the monomers is preferably within the range of 0.001 to 10% by weight in terms of monomer ratio on the basis of the entire monomers since the polymerization efficiency of the monomers is high, the degree of polymerization is high, and the mechanical strength is improved, with the range of 0.01 to 5% by weight being more preferable.

(Electrolyte)

Examples of the electrolyte used in the production method of the present invention are as set forth above for the ionic conduction structural member.

The secondary battery of the present invention and the production method thereof will be explained hereinbelow.

The secondary battery of the present invention has typically the construction wherein the ionic conduction structural member is installed between the positive electrode and the negative electrode provided in opposition to each other so as to make higher the ionic conductivity in the direction. connecting the surface of the negative electrode and the surface of the positive electrode. The method of producing the secondary battery of the present invention typically includes providing the ionic conductor produced by the production method of the ionic conductor described above in contact with and between the negative electrode and the positive electrode so as to make higher the ionic conductivity in the direction connecting the negative electrode surface and the positive electrode surface, taking out output terminals and sealing with a casing.

Examples of the shapes of the secondary battery of the present invention include, for example, a flat type, a cylindrical type, a rectangular parallelepiped type, a sheet type, etc. Further, examples of the structure of the secondary battery includes, for example, a monolayer type, a multilayer type, a spiral type, etc. Of the above-mentioned, a spiral type cylindrical battery has the advantages that an enlarged electrode area can be secured by interposition of a separator between positive and negative electrodes followed by rolling up, and thus a large current can be passed at the time of charging/discharging. Further, the batteries of rectangular parallelepiped type and sheet type have an advantage that they can effectively make use of storage spaces in an apparatus which accommodates and is constituted of a plurality of batteries.

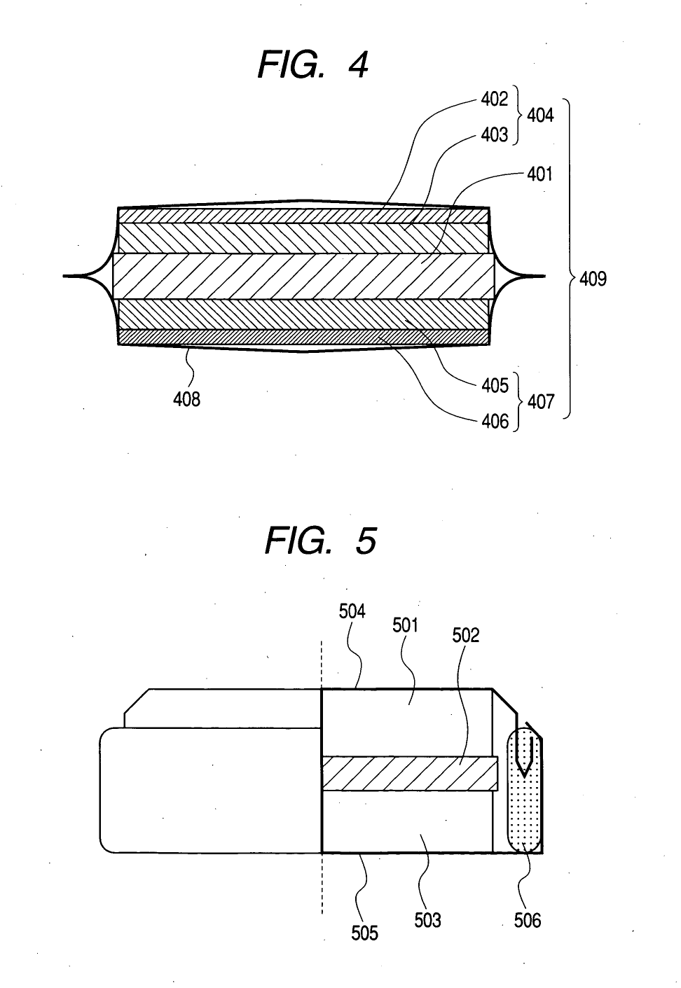

FIG. 4 is a sectional view showing a schematic construction of an example of the single layer sheet type secondary battery. In FIG. 4, reference numeral 401 denotes an ionic conduction structural member, 402 denotes a negative electrode current collector, 403 denotes a negative electrode active material (negative electrode material), 404 denotes a negative electrode, 405 denotes a positive electrode active material (positive electrode material), 406 denotes a positive electrode current collector, 407 denotes a positive electrode, 408 denotes a casing (battery housing), and 409 denotes an electrode stack.

FIG. 5 is a sectional view showing a schematic construction of an example of the single layered flat type (coin type) secondary battery. This secondary battery has fundamentally the same construction as that shown in FIG. 4. In FIG. 5, reference numeral 501 denotes a negative electrode, 502 denotes an ionic conduction structural member, 503 denotes a positive electrode, 504 denotes a negative electrode can (negative terminal), 505 denotes a positive electrode can (positive terminal), and 506 denotes a gasket.

Although the figure shows only the single layered secondary battery, a multi-layered stack secondary battery sandwiching the ionic conductor between the negative electrode and the positive electrode can be produced.

Since using the ionic conduction structural member of the present invention makes it possible to solidify the electrolyte solution between the negative electrode and the positive electrode, no leakage of the solution is generated and sealing of the battery can be made easily, so that the casing of the battery can be made thin, whereby the secondary battery with a desired free shape can easily be produced.

The secondary battery shown in FIG. 4 can be produced by using the ionic conduction structural member, constructing the electrode stack 409 having the structure in which the ionic conduction structural member is sandwiched by the negative electrode 404 and the positive electrode 407, and sealing the electrode stack 409 with the casing 408.

A method of constructing the electrode stack 409 can be mentioned as follows.

(a) The electrode stack 409 is formed by sandwiching the ionic conduction structural member 401 between the negative electrode 404 and the positive electrode 407 so as to adhere the negative electrode 404 and the positive electrode 407 to each other in face-to-face position on the both surfaces of the film-shaped ionic conduction structural member prepared by the production method of the ionic conduction structural member.

(b) On the surface of the negative electrode 404 or the surface of the positive electrode 407, or on the surfaces of both the negative electrode 404 and the positive electrode 407, the film-shaped ionic conduction structural member is formed by the production method of the ionic conduction structural member. Subsequently, the negative electrode 404 and the positive electrode 407 are adhered to each other with the surface provided with the ionic conduction structural member being faced inside, or another one of the ionic conduction structural member is further sandwiched between the negative electrode 404 and the positive electrode 407 and adhered to form the electrode stack 409.

(c) The negative electrode 404 and the positive electrode 407 are positioned in opposition to each other while providing a space (gap) between the both electrodes for preventing direct contact therebetween, for example, the negative electrode 404 and the positive electrode 407 are positioned in opposition to each other through a spacer such as nonwoven fabric, porous film or particles, then the ionic conduction structural member is formed by the production method of the ionic conduction structural member described above in the space (gap) between the negative electrode 404 and the positive electrode 407, for example the ionic conduction structural member is formed by a thermal polymerization of a mixture containing the monomer which can form the ionic conduction structural member, to form the electrode stack 409. At this time, the step of forming the ionic conduction structural member, for example the step of effecting the thermal polymerization of the mixture containing the monomer that can form the ionic conduction structural member can be performed even after the sealing by the casing 408.

Further, at this time, if the negative electrode 404 and/or the positive electrode 407 contains the ionic conduction structural member, adhesion of the ionic conduction structural member and the electrode becomes good and the interface resistance can be reduced to improve the charge/discharge performance, which is preferred, and further if this ionic conduction structural member is the ionic conduction structural member of the present invention, the ionic conductivity becomes good, which is also preferable. Methods for incorporating the ionic conduction structural member into the electrode include a method of impregnating a solution containing at least one selected from the group consisting of polymer, monomer and oligomer as a raw material for the polymer matrix forming the ionic conduction structural member into the negative electrode 404 and the positive electrode 407, and forming the polymer matrix of the ionic conduction structural member by the polymerization reaction of the monomer or the oligomer, or the crosslinking reaction of the polymer or the oligomer in the electrode active material, or a method of forming the electrode active material layer on the current collector by mixing the ionic conduction structural member into the negative electrode active material and positive electrode active material.

In the flat type (coin type) secondary battery shown in FIG. 5, the positive electrode 503 containing positive electrode material layer (active material layer) and the negative electrode 501 having the negative electrode material layer (active material layer) are stacked at least via the ionic conduction structural member 502, and the stack is housed in the positive electrode can 505 as the positive terminal from the positive electrode side and the negative electrode side is covered by the negative electrode cap 504 as the negative terminal. In the other part of the positive electrode can, the gasket 506 is arranged.

A typical assembling process of the battery shown in FIG. 5 will be described below.
(1) The electrode stack, in which the ionic conduction structural member (502) is sandwiched by the negative electrode (501) and the positive electrode (503), is formed according to the method described from (a) to (c) above and is assembled in the positive electrode can (505).
(2) The negative electrode cap (504) and the gasket (506) are assembled.
(3) The assembly obtained in (2) above is caulked to complete the battery.

The preparation of the materials for the battery and the assembly of the battery are preferably carried out in a dry air or a dry inert gas from which moisture has been sufficiently removed.

Referring to FIG. 4, components of the secondary battery of the present invention is explained in detail below.

(Negative Electrode)

The negative electrode (404) consists of the negative electrode current collector (402) and the negative electrode active material layer (403). The term “active material” employed herein is intended to mean those materials involved in the charging/discharging electrochemical reactions (repetition of charge/discharge reactions) in the secondary battery.

In case that the secondary battery is a lithium secondary battery utilizing the oxidation/reduction reactions of lithium ions, materials used for the active material layer of the negative electrode (negative electrode active material) is to maintain lithium during charging, and include metallic lithium, a metal that is electrochemically alloyed with lithium, and an carbon material and a transition metal compound that intercalates lithium. Examples of the meal that is electrochemically alloyed with lithium include Bi, In, Pb, Si, Ag, Sr, Ge, Zn, Sn, Al, Cd, Sb, Tl and Hg. It is preferable that the metal is an alloy having an amorphous phase since good adhesion with the ionic conduction structural member is provided, and an amorphous alloy of Si or Sn is more preferable since a large amount of lithium can be accumulated therein with a high capacity. Examples of the transition metal compound are transition metal oxide, transition metal nitride, transition metal sulfide and transition metal carbide. Examples of transition metal element of the transition metal compound are elements having partially filled d-shell or f-shell, i.e. Sc, Y, lanthanide, actinoid, Ti. Zr, Hf, V, Nb, Ta, Cr, Mo, W, Mn, Tc, Re, Fe, Ru, Os, Co, Rh, Ir, Ni, Pd, Pt, Cu, Ag and Au. Especially, the first transition series metal such as Ti, V, Cr, Mn, Fe, Co, Ni and Cu is preferable.

In case that the negative electrode active material is in a powder state, a binder is mixed, if necessary a conductive auxiliary material is further added, and the negative electrode active material layer is formed on the current collector by coating or pressing to prepare the negative electrode. When the negative electrode active material is a foil or plate, these are adhered on the current collector by pressing to prepare the negative electrode. In addition, the negative electrode can be prepared by a method of forming a thin film of the predetermined negative electrode active material on the current collector by plating or vapor deposition. Examples of the vapor deposition are CVD (chemical vapor deposition), electron beam deposition, spattering, etc. The thus prepared negative electrode is necessary to dry completely under reduced pressure.

Examples of the binder used for preparation of the negative electrode are polyolefin such as polyethylene and polypropylene, fluororesin such as poly(vinylidene fluoride) and tetrafluoroethylene polymer, poly(vinyl alcohol), sodium carboxymethyl cellulose,.cellulose and polyamide. When the ionic conduction structural member is directly formed on the negative electrode, if the binder having hydrophobicity such as fluororesin is used, the orientation property of the polymer matrix is more improved and is preferable.

The negative electrode current collector has a role to supply effectively the current to be consumed or to collect the generated current in the electrode reactions during charging/discharging. Consequently, the constituent material of the negative electrode current collector preferably has a high conductivity and is inert to the battery reaction. Such preferable materials are nickel, titanium, copper, aluminum, stainless steel, platinum, palladium, gold, zinc, various alloys, and complex metal consisting of two or more metals. The form of the negative electrode current collector is for example plate type, foil type, mesh type, sponge type, fiber type, punching metal and expand metal.

(Positive Electrode)

The positive electrode (407) consists of the positive electrode current collector (406) and the positive electrode active material (405).

In case that the secondary battery is a lithium secondary battery utilizing the oxidation/reduction reactions of lithium ions, the material used for the active material layer of the positive electrode is to maintain lithium during discharging, and includes transition metal compounds that intercalate lithium, such as transition metal oxide, transition metal nitride and transition metal sulfide. Examples of the transition metal element of the transition metal compounds are elements having partially filled d-shell or f-shell, i.e. Sc, Y, lanthanide, actinoid, Ti. Zr, Hf, V, Nb, Ta, Cr, Mo, W, Mn, Tc, Re, Fe, Ru, Os, Co, Rh, Ir, Ni, Pd, Pt, Cu, Ag and Au. Especially, the first transition series metal such as Ti, V, Cr, Mn, Fe, Co, Ni and Cu is preferable. In case of using a negative electrode active material not containing lithium when assembling the battery, it is preferable to use as the positive electrode material, a compound such as lithium/transition metal oxide that contains lithium.

The positive electrode (407) generally consists of the current collector (406), the positive electrode active material (405), the conductive auxiliary material, binder, etc. The positive electrode is produced by molding the mixture of predetermined positive electrode active material, predetermined conductive auxiliary material and predetermined binder on the surface of the current collector.

Examples of the conductive auxiliary material are graphite, carbon black such as ketjenblack and acetylene black and a powder of a metal such as nickel.

Examples of the binder include polyolefin such as polyethylene and polypropylene, fluororesin such as poly(vinylidene fluoride) and tetrafluoroethylene polymer, poly(vinyl alcohol), cellulose and polyamide. When the ionic conduction structural member is directly formed on the positive electrode, if a binder having hydrophobicity such as fluororesin is used, the orientation property of the polymer matrix is more improved and is preferable.

The positive electrode current collector has a role to supply effectively the current to be consumed or to collect the generated current in the electrode reaction during the charging/discharging. Consequently, the constitutive materials of the positive electrode current collector preferably has a high conductivity and is inert to the battery reaction. Such preferable materials are nickel, titanium, aluminum, stainless steel, platinum, palladium, gold, zinc, various alloys, and complex metal consisting of two or more metals. The form of the positive electrode current collector is for example plate type, foil type, mesh type, sponge type, fiber type, punching metal and expand metal.

(Insulating Packing)

Examples of the material for the gasket (506) are fluororesin, polyolefin resin, polyamide resin, polysulfone resin and various types of rubber.

(Casing/Battery Housing)

The battery housing for containing the components in the secondary battery is formed from the positive electrode can of the battery 505 and negative electrode cap 504 in the example shown in FIG. 5. In the example shown in FIG. 5, since the positive electrode can 505 and the negative electrode cap 504 serve also as the battery housing (case) and output/input terminals, stainless steel is preferably used.

As shown in the example of FIG. 4, when the casing 408 of the secondary battery does not serve also as the housing, a composite material of plastic and metal such as a laminated film prepared by laminating a plate-shaped or film-shaped plastic material, a metallic foil or a vapor deposited metal film with a plastic film can preferably be used. In case that the secondary battery of the present invention is a lithium secondary battery, it is preferable that the casing is made of a water vapor or gas impermeable material, and it is essential to attain hermetic sealing for closing an intruding path of water vapor.

### EXAMPLES

The present invention is explained in detail by the following examples. However, these examples are only illustrative and the present invention is not limited by these examples. In the following examples, amount indicated by “parts” and “%” means “parts by weight” and “% by weight”.

### Example 1

In this example, an ionic conduction structural member was prepared as described hereinbelow.

(1) Preparation of Ionic Conduction Structural Member:

The first monomer, methoxy-eicosaethyleneoxy-block-eicosapropyleneoxy-acrylate (3.2 parts) (the number of ethylene oxide: 20, the number of propylene oxide: 20), the monomer having a blocked polyethylene oxide group and a blocked polypropylene oxide group in the side chain; the second monomer, methoxy-triethyleneoxy-methacrylate (2.0 parts) (the number of ethylene oxide: 3), the monomer having ethylene oxide group in the side chain; and the third monomer (the crosslinking agent), polyethylene glycol dimethacrylate (the number of ethylene oxide: 23) (0.6 parts) were added to an electrolyte prepared by mixing in a ratio of propylene carbonate (50.0 parts), ethylene carbonate (50.0 parts) and the electrolyte, lithium tetrafluoroborate 10.3 parts, and warmed at 40° C. with stirring well to dissolve uniformly.

Azobisisobutyronitrile, a radical polymerization initiator, (0.02 parts) was added to the obtained mixed solution. The mixed solution was inserted into a cell (polymerization vessel 301 in FIG. 3) constructed with 2 plates of the quartz glass, in which the fluororesin layer was formed on one side, and a spacer (thickness 50 μm) made of Teflon (trade name). At this time, the surface of the quartz glass having the formed fluororesin layer was made to face inside of the cell. The angle of contact with water on the surface of the quartz glass (resin layer was formed on the surface) was measured to give 117°. Subsequently, the cell was heated at 70° C. for 1 hour to perform a polymerization reaction. The polymerized product was taken out from the cell to obtain a film-shaped ionic conduction structural member (width 10 cm×length 6 cm×thickness 50 μm). Each monomer used herein was the monomer having uniform molecular weight obtained by column chromatographic separation.

(2) Evaluation of Ionic Conduction Structural Member

The thus obtained ionic conduction structural member was analyzed by IR spectrometry, NMR spectrometry and mass spectrometry. The results indicated that the ionic conduction structural member was estimated to have the crosslinked structure that was formed by polymerization with the same ratio of monomers at the time of the initial preparation. For confirmation, when the obtained ionic conduction structural member was gradually heated up to 300° C., only oxidation was observed without melting, and it was confirmed that the polymer matrix formed a chemically bonded crosslinked structure. In order to analyze the ratio of unreacted monomers in the obtained ionic conduction structural member, the ionic conduction structural member was immersed in tetrahydrofuran solution for one day, and the tetrahydrofuran solution was analyzed by gel-permeation chromatography (GPC). The results indicated that unreacted monomer and low molecular weight polymerization product were not observed, and all monomers were believed to be chemically bonded in the polymer matrix. The ratio of the total number of —CH₂—CH₂—O— groups in the obtained polymer matrix/the total number of —CH₂—CH(CH₃)—O— groups in the entire polymer matrix was 2.24.

Further, the film surface of the ionic conduction structural member was observed under cross-Nicol polarized light by using a polarization microscope. Changes from dark-field to bright-field were observed in most area of the film surface (dark-field was slightly observed in the largest numbers of bright-field), and the structure, in which the polymer skeleton was arranged in the direction parallel to the film surface, was observed. The relaxation temperature of the side chain of the polymer chain in the ionic conduction structural member was measured by using a viscoelasticity measurement system (DMS). Measurement was also performed by using an X-ray small angle scattering measurement apparatus below the relaxation temperature of the side chain part in every direction including the direction parallel to the film surface (X-axis and Y-axis direction) and the film thickness direction (Z-axis). In the measurement, the shape of the sample in the measurement direction was adjusted to be constant.

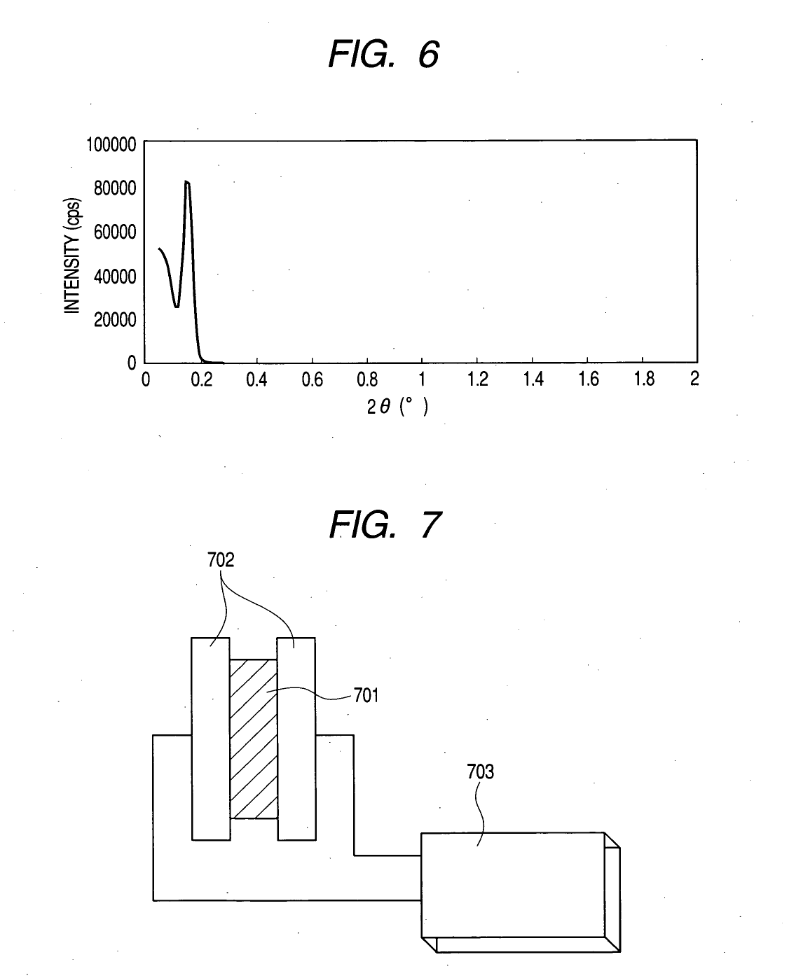

The result indicated that when measurement was performed in the thickness direction (Z-axis direction) to the film surface, the peak shown in FIG. 6 appeared, and when measurement was performed in other directions, the peak intensity in this position was considerably smaller than the peak intensity of the Z-axis. At this time, the peak intensity of the Z-axis direction was 5.5 times stronger in the peak intensity ratio as compared with that in the direction of the weakest peak intensity. Further, in the direction along to X-axis of the film surface (X-axis direction), a peak appeared in the different position from the peak position in FIG. 6. The peak in this position did not appear in a direction other than the direction along to the film surface (XY plane direction). The peak intensity at that time was strongest in the X-axis direction and the ratio of the peak intensity was 6.0 times larger than that in the direction with weakest peak intensity in Other XY plane direction. Subsequently, similar measurement was performed in the thickness direction (Z-axis) to the film surface while heating the sample at 100° C., a temperature above the relaxation temperature of the side chain part. As a result, changes, in which the peak intensity was decreased depending on the increased temperature, were observed in the peak in FIG. 6. The results indicated that the orientation of the side chain shown in FIG. 1A was destroyed by heating. Such changes were almost not observed except for the direction perpendicular to the film surface. From the above results, it was believed that in the obtained ionic conduction structural member, the main chain part of the polymer chain was oriented parallel to the film surface and the side chain part was oriented in the thickness direction. The results are shown in Table 1.

The film-shaped ionic conduction structural member was sandwiched by additional 2 stainless steel plates, connected as shown in FIG. 7, the resistance value of the ionic conduction structural member 701 between both electrodes 702 was measured. Measurement of impedance was performed by using the impedance measurement apparatus 703 consisting of milliohm meter, at an input voltage 0.1 V using measurement signal of 1 kHz sign wave, and the resistance value r was obtained while measuring the thickness d and the area A of the ionic conduction structural member, and the ionic conductivity in the thickness direction of the film-shaped ionic conduction structural member was calculated from the equation (Ionic Conductivity σ=d/(A×r).

The film-shaped ionic conduction structural member was brought into close contact with a gap electrode, which was prepared by bringing a mask of a negative pattern of the gap electrode into close contact with a glass substrate and subjecting it to electron-beam evaporation of aluminum, and the resistance value of the ionic conduction structural member between the both electrodes was measured.

Measurement of impedance was performed in the same way as above by using the impedance measurement apparatus consisting of milliohm meter using measurement signal of 1 kHz sign wave, and the resistance value r was obtained while measuring the thickness d of the ionic conduction structural member, and the ionic conductivity in the film surface direction of the film-shaped ionic conduction structural member was calculated from the equation (ionic conductivity σ=(gap width between electrodes in gap electrode, w)/(length of gap electrode L×d×r). A value of the ionic conductivity of the film-shaped ionic conduction structural member for the thickness direction is 8.0 times larger than for the film surface direction, indicating anisotropic ionic conductivity. Further, the ionic conductivity at a low temperature was measured, and was better as compared with that of the Comparative Example. Results are shown in Table 1.

### Examples 2 to 5

(1) Preparation of Ionic Conduction Structural Member

In each of Examples 2 to 5, an ionic conduction structural member was prepared in the same manner as described in Example 1 with the exception that the first monomer and the second monomer were replaced as indicated below and a mixed solution prepared as described below was used.

The first monomer, i.e. the monomer having a blocked polyethylene oxide group and a blocked polypropylene oxide group in the side chain, used in Examples 2 to 5 was as follows.

In Example 2: ethoxy-triacontaethyleneoxy-block-decapropyleneoxy-acrylate (the number of ethylene oxide: 30, the number of propylene oxide: 20) (2.0 parts); in Example 3: methoxy-decaethyleneoxy-block-tetracontapropyleneoxy-acrylate (the number of ethylene oxide: 10, the number of propylene oxide: 40) (3.15 parts); in Example 4: ethoxy-hexacontaethyleneoxy-block-pentapropyleneoxy-methacrylate (the number of ethylene oxide: 60, the number of propylene oxide: 5) 5.86 parts; and in Example 5: butoxy-pentaethyleneoxy-block-nonacontapropyleneoxy-acrylate (the number of ethylene oxide: 5, the number of propylene oxide: 90) (9.05 parts).

The second monomer, i.e. the monomer having an ethylene oxide group in the side chain used in Examples 2 to 5 was as follows.

In Example 2: ethoxy-nonaethyleneoxy-acrylate (the number of ethylene oxide: 9) (3.53 parts); in Example 3: methoxy-hexaethyleneoxy-acrylate (the number of ethylene oxide: 6) (2.40 parts); in Example 4: ethoxy-diethyleneoxy-methacrylate (the number of ethylene oxide: 2) (5.05 parts); and in Example 5: butoxy-triacontaethyleneoxy-acrylate (the number of ethylene oxide: 30) (2.83 parts). The third monomer (the crosslinking agent) used was the same as described in Example 1, i.e. polyethylene glycol dimethacrylate (the number of ethylene oxide: 23), and amount used in Examples 2 to 5 was as follows. In Example 2: 0.24 parts; in Example 3: 0.26 parts; in Example 4: 0.92 parts; and in Example 5: 0.17 parts. The first monomer, the second monomer and the third monomer were added to the electrolyte solution, which was obtained by mixing with propylene carbonate (50.0 parts), ethylene carbonate (50.0 parts) and the electrolyte lithium tetrafluoroborate 10.3 parts, and heated at 40° C. with stirring well for dissolving uniformly. Subsequent procedure was performed in the same way as described in Example 1 to obtain four types of the film-shaped ionic conduction structural member. The monomer used in the above was the product having uniform molecular weight obtained by column chromatographic separation.

(2) Evaluation of Ionic Conduction Structural Member

Each of the thus obtained ionic conduction structural members was analyzed by IR spectrometry, NMR spectrometry and mass spectrometry. The results indicated that each ionic conduction structural member was estimated to have the crosslinked structure that was formed by polymerization with the same ratio of monomers at the time of the initial preparation. For confirmation, when each of the obtained ionic conduction structural members was gradually heated up to 300° C., only oxidation was observed without melting, and it was confirmed that the polymer matrix formed a chemically bonded crosslinked structure. In order to analyze a ratio of unreacted monomers in the obtained ionic conduction structural member, each of the ionic conduction structural members was immersed in tetrahydrofuran solution for one day, and the tetrahydrofuran solution was analyzed by gel-permeation chromatography (GPC). The result indicated that unreacted monomer and low molecular weight polymerization product were not observed in any cases, and all monomers were believed to be chemically bonded in the polymer matrix. The ratios of the total number of —CH₂—CH₂—O— groups contained in the obtained polymer matrix/the total number of —CH₂—CH(CH₃)—O— groups contained in the entire polymer matrix in the examples were: 9.76 in Example 2; 1.01 in Example 3; 19.96 in Example 4; and 0.51 in Example 5.

The orientation property was measured for each of the obtained ionic conduction structural members in the same manner as described in Example 1 using a polarizing microscope, a viscoelasticity measurement apparatus (DMS) and an X-ray small angle scattering measurement apparatus. As a result, it was believed that in each of the obtained ionic conduction structural members, the main chain part of the polymer chain was oriented parallel to the film surface and the side chain part was oriented in the thickness direction. Further, the ionic conductivity of each of the ionic conduction structural members was measured in the same manner as described in Example 1. It was found that each had the anisotropic ionic conductivity. The ionic conductivity at a low temperature was measured and was found to be better as compared with the Comparative Examples. The results are shown in Table 1.

The ratio of the total number of —CH₂—CH₂—O— groups/the total number of —CH₂—CH(CH₃)—O— groups contained in the polymer matrix and the orientation property of the side chain of the segment having polyethylene oxide group and polypropylene oxide group in the side chain as well as those of Example 1 were compared. It was found that as shown in FIG. 10, in case of the ratio of the total number of —CH₂—CH₂—O— groups/the total number of —CH₂—CH(CH₃)—O— groups being 1 to 10, the orientation property was more improved.

FIG. 10 is a view showing correlation between the ratio of the total number of —CH₂—CH₂—O— groups/total number of —CH₂—CH(CH₃)—O— groups contained in the polymer matrix constituting the ionic conduction structural member of the present invention and the orientation property of the ionic conduction structural member. In FIG. 10, the orientation degree of the side chain of the ionic conduction structural member is expressed as the ratio of peak intensity corresponding to the side chain part measured by the X-ray small angle scattering measurement apparatus as follows.

Orientation Degree=the peak intensity in the direction having a highest peak intensity/the peak intensity in the direction having a lowest peak intensity.

### Examples 6 to 9

(1) Preparation of Ionic Conduction Structural Member

In each of Examples 6 to 9, an ionic conduction structural member was prepared in the same manner as described in Example 1 with the exception that as the first monomer, in place of methoxy-eicosaethyleneoxy-block-eicosapropyleneoxy-acrylate (the number of ethylene oxide: 20, the number of propylene oxide: 20) used in Example 1, a monomer having different number of ethylene oxides in the polyethylene oxide group was used, and a mixed solution prepared as described below was used.

The first monomer, i.e. the monomer having side chain of the blocked polyethylene oxide group and polypropylene oxide group, used in Examples 6 to 9 was as follows: In Example 6: methoxy-pentaethyleneoxy-block-eicosapropyleneoxy-acrylate (the number of ethylene oxide: 5, the number of propylene oxide: 20) (2.67 parts); in Example 7: methoxy-decaethyleneoxy-block-eicosapropyleneoxy-acrylate (the number of ethylene oxide: 10, the number of propylene oxide: 20) (2.87 parts); in Example 8: methoxy-pentacontaethyleneoxy-block-eicosapropyleneoxy-acrylate (the number of ethylene oxide: 50, the number of propylene oxide: 20) (3.87 parts); and in Example 9: methoxy-hectaethyleneoxy-block-eicosapropyleneoxy-acrylate (the number of ethylene oxide: 100, the number of propylene oxide: 20) (4.45 parts). The second monomer, i.e. the monomer having an ethylene oxide group in the side chain used in Examples 6 to 9 was the same as in Example 1, i.e. methoxy-triethyleneoxy-methacrylate (the number of ethylene oxide: 3), and amount used was as follows: In Example 6: 2.41 parts; in Example 7: 2.25 parts; in Example 8: 1.49 parts; and in Example 9: 1.04 parts. The third monomer, a crosslinking agent, polyethylene glycol dimethacrylate (the number of ethylene oxide: 23) used is in Example 6: 0.72 parts; in Example 7: 0.68 parts; in Example 8: 0.45 parts; and in Example 9: 0.31 parts. The first monomer, the second monomer and the third monomer were added to the electrolyte solution, which was obtained by mixing with propylene carbonate (50.0 parts), ethylene carbonate (50.0 parts) and the electrolyte lithium tetrafluoroborate (10.3 parts), and heated at 40° C. with stirring well for dissolving uniformly. Subsequent procedure was performed in the same way as described in Example 1 to obtain four types of the film-shaped ionic conduction structural member. The monomer used in the above was the product having uniform molecular weight obtained by column chromatographic separation.

(2) Evaluation of Ionic Conduction Structural Member

Each of the thus obtained ionic conduction structural members was analyzed by IR spectrometry, NMR spectrometry and mass spectrometry. The results indicated that each of the ionic conduction structural members was estimated to have the crosslinked structure that was formed by polymerization with the same ratio of monomers at the time of the initial preparation. For confirmation, when each of the obtained ionic conduction structural members was gradually heated up to 300° C., only oxidation was observed without melting, and it was confirmed that the polymer matrix formed a chemically bonded crosslinked structure. In order to analyze the ratio of unreacted monomers in the obtained ionic conduction structural member, each of the ionic conduction structural members was immersed in tetrahydrofuran solution for one day, and the tetrahydrofuran solution was analyzed by qel-permeation chromatography (GPC). The result indicated that unreacted monomer and low molecular weight polymerization product were not observed in any cases, and all monomers were believed to be chemically bonded in the polymer matrix. The ratios of the total number of —CH₂—CH₂—O— groups contained in the obtained polymer matrix/the total number of —CH₂—CH(CH₃)—O— groups contained in the entire polymer matrix in the examples were: 1.49 in Example 6; 1.73 in Example 7; 3.73 in Example 8; and 6.23 in Example 9. In addition, the product obtained in Example 9 was observed as having slightly decreased tendency of the mechanical strength as compared with Examples 6 to 8.

The orientation property was measured for each of the obtained ionic conduction structural members in the same manner as described in Example 1 using a polarizing microscope, a viscoelasticity measurement apparatus (DMS) and an X-ray small angle scattering measurement apparatus. As a result, it was believed that in each of the obtained ionic conduction structural members, the main chain part of the polymer chain was oriented parallel to the film surface and the side chain part was oriented in the thickness direction. Further, the ionic conductivity of each of the ionic conduction structural members was measured in the same manner as described in Example 1. It was found that each had the anisotropic ionic conductivity. The ionic conductivity at a low temperature was measured and was found to be better as compared with the Comparative Examples described below. The results are shown in Table 1.

The number of ethylene oxides of the segment having polyethylene oxide group and polypropylene oxide group in the side chain and the orientation property and those of Example 1 and Comparative Example 2 were compared. As shown in FIG. 8, when the number of ethylene oxides was 5 or more, the orientation property was improved as compared with the case having the number 2 of ethylene oxides in Comparative Example 2, the orientation property was improved, and in case of the number of ethylene oxide 10 or more, it was found that the orientation property was further improved.

FIG. 8 is a view showing the correlation between the number of ethylene oxides in the segment having a polyethylene oxide group and a polypropylene oxide group in the side chain forming the ionic conduction structural member of the present invention and the orientation property. In FIG. 8, the orientation degree of the side chain of the ionic conduction structural member is expressed as the ratio of peak intensity corresponding to the side chain part measured by the X-ray small angle scattering measurement apparatus as follows.

Orientation Degree=the peak intensity in the direction having a highest peak intensity/the peak intensity in the direction having a lowest peak intensity.

### Examples 10 to 13

(1) Preparation of Ionic Conduction Structural Member

In each of Examples 10 to 13, an ionic conduction structural member was prepared in the same manner as described in Example 1 with the exception that as the first monomer, in place of methoxy-eicosaethyleneoxy-block-eicosapropyleneoxy-acrylate (the number of ethylene oxide: 20, the number of propylene oxide: 20) used in Example 1, a monomer having different number of propylene oxides in the polypropylene oxide group was used, and a mixed solution prepared as described below was used.

The first monomer, i.e. the monomer having a blocked polyethylene oxide group and a blocked polypropylene oxide group in the side chain, used in Examples 10 to 13 was as follows: In Example 10: methoxy-eicosaethyleneoxy-block-pentapropyleneoxy-acrylate (the number of ethylene oxide: 20, the number of propylene oxide: 5) 2.45 parts; in Example 11: methoxy-eicosaethyleneoxy-block-decapropyleneoxy-acrylate (the number of ethylene oxide: 20, the number of propylene oxide: 10) 2.75 parts; in Example 12: methoxy-eicosaethyleneoxy-block-pentacontapropyleneoxy-acrylate (the number of ethylene oxide: 20, the number of propylene oxide: 50) 4.02.parts; and in Example 13: methoxy-eicosaethyleneoxy-block-hectapropyleneoxy-acrylate (the number of ethylene oxide: 200, the number of propylene oxide: 100) (4.63 parts). The second monomer, i.e. the monomer having an ethylene oxide group in the side chain used in Examples 10 to 13 was the same as in Example 1, i.e. methoxy-triethyleneoxy-methacrylate (the number of ethylene oxide: 3), and amount used was as follows: In Example 10: 2.58 parts; in Example 11: 2.35 parts; in Example 12: 1.38 parts; and in Example 13: 0.91 parts. The third monomer, a crosslinking agent, polyethylene glycol dimethacrylate (the number of ethylene oxide: 23) used is in Example 10: 0.77 parts; in Example 11: 0.71 parts; in Example 12: 0.41 parts; and in Example 13: 0.27 parts. The first monomer, the second monomer and the third monomer were added to the electrolyte solution, which was obtained by mixing with propylene carbonate (50.0 parts), ethylene carbonate (50.0 parts) and the electrolyte lithium tetrafluoroborate 10.3 parts, and heated at 40° C. with stirring well for dissolving uniformly. Subsequent procedure was performed in the same way as described in Example 1 to obtain four types of the film-shaped ionic conduction structural member. The monomer used in the above was the product having uniform molecular weight obtained by column chromatographic separation.

(2) Evaluation of Ionic Conduction Structural Member

Each of the thus obtained ionic conduction structural members was analyzed by IR spectrometry, NMR spectrometry and mass spectrometry. The results indicated that each of the ionic conduction structural members was estimated to have the crosslinked structure that was formed by polymerization with the same ratio of monomers at the time of the initial preparation. For confirmation, when each of the obtained ionic conduction structural members was gradually heated up to 300° C., only oxidation was observed without melting, and it was confirmed that the polymer matrix formed a chemically bonded crosslinked structure. In order to analyze the ratio of unreacted monomers in the obtained ionic conduction structural member, each of the ionic conduction structural members was immersed in tetrahydrofuran solution for one day, and the tetrahydrofuran solution was analyzed by gel-permeation chromatography (GPC). The result indicated that unreacted monomer and low molecular weight polymerization product were not observed in any cases, and all monomers were believed to be chemically bonded in the polymer matrix. The ratios of the total number of —CH₂—CH₂—O— groups contained in the obtained polymer matrix/the total number of —CH₂—CH(CH₃)—O— groups contained in the entire polymer matrix in the examples were: 8.94 in Example 10; 4.47 in Example 11; 1.18 in Example 12; and 0.45 in Example 13. In addition, product obtained in Example 13 was observed as having slightly decreased tendency of the mechanical strength as compared with Examples 10 to 12.

The orientation property was measured for each of the obtained ionic conduction structural member in the same manner as described in Example 1 using a polarizing microscope, a viscoelasticity measurement apparatus (DMS) and an X-ray small angle scattering measurement apparatus. As a result, it was believed that in each of the obtained ionic conduction structural members, the main chain part of the polymer chain was oriented parallel to the film surface and the side chain part was oriented in the thickness direction. Further, the ionic conductivity of each of the ionic conduction structural members was measured in the same manner as described in Example 1. It was found that each had the anisotropic ionic conductivity. The ionic conductivity at a low temperature was measured and was found to be better as compared with the Comparative Examples. The results are shown in Table 1.

The number of propylene oxides of the segment having a polyethylene oxide group and a polypropylene oxide group in the side chain and the orientation property and those of Example 1 and Comparative Example 3 were compared. As shown in FIG. 9, when the number of propylene oxide was 5 or more, the orientation property was improved as compared with the case having the number 2 of propylene oxides in Comparative Example 3, the orientation property was improved, and in case of the number of propylene oxide 10 or more, it was found that the orientation property was further improved.

FIG. 9 is the view showing the correlation between the number of propylene oxides in the segment having the polyethylene oxide group and the polypropylene oxide group forming the ionic conduction structural member of the present invention and the orientation property. In FIG. 9, the orientation degree of the side chain of the ionic conduction structural member is expressed as the ratio of peak intensity corresponding to the side chain part measured by the X-ray small angle scattering measurement apparatus as follows.

Orientation Degree=the peak intensity in the direction having a highest peak intensity/the peak intensity in the direction having a lowest peak intensity.

### Example 14

(1) Preparation of Ionic Conduction Structural Member

In this example, an ionic conduction structural member was prepared in the same manner as described in Example 1 with the exception that a mixed solution prepared as described below was used.

The first monomer, methoxy-eicosapropyleneoxy-block-eicosaethyleneoxy-acrylate 1.58 parts (the number of propylene oxide: 20, the number of ethylene oxide: 20), the monomer having side chain of blocked polyethylene oxide group and polypropylene oxide group; the second monomer, methoxy-hectaethyleneoxy-acrylate (3.35 parts) (the number of ethylene oxide: 100), the monomer having a ethylene oxide group in the side chain; and the third monomer (the crosslinking agent), polyethylene glycol dimethacrylate (the number of ethylene oxide: 13) (0.27 parts) were added to the electrolyte prepared by admixing in a ratio of propylene carbonate (50.0 parts), ethylene carbonate (50.0 parts) and the electrolyte, lithium hexafluorophosphate (10.3 parts), and warmed at 40° C. with stirring well to dissolve uniformly. The monomer used in the above was the product having uniform molecular weight obtained by column chromatographic separation.

(2) Evaluation of Ionic Conduction Structural Member

The thus obtained ionic conduction structural member was analyzed by IR spectrometry, NMR spectrometry and mass spectrometry. The result indicated that the ionic conduction structural member was estimated to have the crosslinked structure that was formed by polymerization with the same ratio of monomers at the time of the initial preparation. For confirmation, when the obtained ionic conduction structural member was gradually heated up to 300° C., only oxidation was observed without melting, and it was confirmed that the polymer matrix formed a chemically bonded crosslinked structure. In order to analyze the ratio of unreacted monomers in the obtained ionic conduction structural member, the ionic conduction structural member was immersed in tetrahydrofuran solution for one day, and the tetrahydrofuran solution was analyzed by gel-permeation chromatography (GPC). The result indicated that unreacted monomer and low molecular weight polymerization product were not observed, and all monomers were believed to be chemically bonded in the polymer matrix. The ratio of the total number of —CH₂—CH₂—O— groups contained in the polymer matrix/the total number of —CH₂—CH(CH₃)—O— groups contained in the entire polymer matrix was 6.58. In addition, the product obtained in Example 14 was observed as having slightly decreased tendency of the mechanical strength as compared with Example 1.

The orientation property was measured for the obtained ionic conduction structural member in the same manner as described in Example 1 using a polarizing microscope, a viscoelasticity measurement apparatus (DMS) and an X-ray small angle scattering measurement apparatus. As a result, it was believed that in the obtained ionic conduction structural member, the main chain part of the polymer chain was oriented parallel to the film surface and the side chain part was oriented in the thickness direction. Further, measurement of the ionic conductivity of the ionic conduction structural member performed in the same manner as described in Example 1 indicated to have the anisotropic ionic conductivity. The ionic conductivity at a low temperature was measured and was found to be better as compared with the Comparative Examples. The results are shown in Table 1.

### Example 15

(1) Preparation of Ionic Conduction Structural Member

In this example, an ionic conduction structural member was prepared in the same manner as described in Example 1 with the exception that a mixed solution prepared as described below was used.

The first monomer, ethoxy-triacontapropyleneoxy-block-decaethyleneoxy-acrylate (21.38 parts) (the number of propylene oxide: 30, the number of ethylene oxide: 10), the monomer having a blocked polyethylene oxide group and a polypropylene oxide group in the side chain; the second monomer, 2-methoxy-ethoxy-methacrylate (4.62 parts) (the number of ethylene oxide: 1), the monomer having side chain of ethylene oxide group; and the third monomer (the crosslinking agent), 1,9-nonanediol dimethacrylate 1.58 parts were added to the electrolyte prepared by admixing in a ratio of a-butyrolactone 50.0 parts, ethylene carbonate (50.0 parts) and the electrolyte, lithium hexafluorophosphate (10.3 parts), and warmed to 40° C. with stirring well to dissolve uniformly. Subsequent process was performed in the same manner as in Example 1 to obtain the film-shaped ionic conduction structural member. The monomer used in the above was the product having uniform molecular weight obtained by column chromatographic separation.

(2) Evaluation of Ionic Conduction Structural Member

The thus obtained ionic conduction structural member was analyzed by IR spectrometry, NMR spectrometry and mass spectrometry. The result indicated that the ionic conduction structural member was estimated to have the crosslinked structure that was formed by polymerization with the same ratio of monomers at the time of the initial preparation. For confirmation, when the obtained ionic conduction structural member was gradually heated up to 300° C., only oxidation was observed without melting, and it was confirmed that the polymer matrix formed a chemically bonded crosslinked structure. In order to analyze the ratio of unreacted monomers in the obtained ionic conduction structural member, the ionic conduction structural member was immersed in tetrahydrofuran solution for one day, and the tetrahydrofuran solution was analyzed by gel-permeation chromatography (GPC). The result indicated that unreacted monomer and low molecular weight polymerization product were not observed, and all monomers were believed to be chemically bonded in the polymer matrix. The ratio of the total number of —CH₂—CH₂—O— groups contained in the obtained polymer matrix/the total number of —CH₂—CH(CH₃)—O— groups contained in the entire polymer matrix was 0.433.

The orientation property was measured for the obtained ionic conduction structural member in the same manner as described in Example 1 using polarizing microscope, viscoelasticity measurement apparatus (DMS) and X-ray small angle scattering measurement apparatus. As a result, it was believed that in the obtained ionic conduction structural member, the main chain part of the polymer chain was oriented parallel to the film surface and the side chain part was oriented in the thickness direction. Further, measurement of the ionic conductivity of the ionic conduction structural member performed in the same manner as described in Example 1 indicated to have the anisotropic ionic conductivity. The ionic conductivity at a low temperature was measured and was found to be better as compared with the Comparative Examples. The results are shown in Table 1.

### Example 16

In this example, an ionic conduction structural member was produced in the same manner as described in Example 1 with the exception that in place of the quartz glass cell coated with fluororesin layer, electrodes prepared by the following method and a support as a porous film were used.

Manufacture of Electrode:

Polyfluorovinylidene powder (10 parts) was mixed with fine powder of natural graphite (90 parts), which was thermal treated at 2000° C. under argon gas atmosphere, and N-methyl-2-pyrrolidone (100 parts) was added thereto to prepare a paste. The thus obtained paste was coated on the copper foil and dried in vacuo at 150° C. to prepare 2 sheets of electrodes.

The two sheets of electrodes obtained hereinabove were stacked on both sides of a polyethylene porous film with the electrode surfaces facing inside, and the mixed solution before polymerization prepared in Example 1 was impregnated into the porous film and electrode layers. The angle of contact of water with the electrode surface prepared in the above was 65°.

The thus obtained ionic conduction structural member was analyzed by IR spectrometry, NMR spectrometry and mass spectrometry. The result indicated that the ionic conduction structural member was estimated to have the crosslinked structure that was formed by polymerization with the same ratio of monomers at the time of the initial preparation. For confirmation, when the obtained ionic conduction structural member was gradually heated up to 300° C., only oxidation was observed without melting, and it was confirmed that the polymer matrix formed a chemically bonded crosslinked structure. In order to analyze the ratio of unreacted monomers in the obtained ionic conduction structural member, the ionic conduction structural member was immersed in tetrahydrofuran solution for one day, and the tetrahydrofuran solution was analyzed by gel-permeation chromatography (GPC). The result indicated that unreacted monomer and low molecular weight polymerization product were not observed, and all monomers were believed to be chemically bonded in the polymer matrix.

The orientation property was measured for the obtained ionic conduction structural member in the same manner as described in Example 1 using a polarizing microscope, a viscoelasticity measurement apparatus (DMS) and an X-ray small angle scattering measurement apparatus. As a result, it was believed that in the obtained ionic conduction structural member, the main chain part of the polymer chain was oriented parallel to the film surface and the side chain part was oriented in the thickness direction. Further, measurement of the ionic conductivity of the ionic conduction structural member performed in the same manner as described in Example 1 indicated to have the anisotropic ionic conductivity. The ionic conductivity at a low temperature was measured and was found to be better as compared with Comparative Example 5. The results are shown in Table 1.

### Comparative Example 1

(1) Manufacture of Ionic Conduction Structural Member

In this Comparative Example, an ionic conduction structural member was produced without using the monomer having polyethylene oxide group and polypropylene oxide group in the side chain used in Example 1.

Methoxy-triethyleneoxy-methacrylate (the number of ethylene oxide: 3) (5.2 parts) and polyethylene glycol dimethacrylate (the number of ethylene oxide: 23) (0.6 parts) were added to an electrolyte solution obtained by mixing with propylene carbonate (50.0 parts), ethylene carbonate (50.0 parts) and an electrolyte lithium tetrafluoroborate (10.3 parts), and warmed to 40° C. with stirring well for obtaining an uniform solution. Subsequent process was performed in the same manner as in Example 1 to obtain a film-shaped ionic conduction structural member.

(2) Evaluation of Ionic Conduction Structural Member

The thus obtained ionic conduction structural member was measured in the same manner as described in Example 1 using a polarizing microscope, a viscoelasticity measurement apparatus and an X-ray small angle scattering measurement apparatus. As a result, the main chain part and side chain part of the polymer chain in the obtained ionic conduction structural member have no orientation property. The ionic conductivity of the thickness direction and the surface direction of the ionic conduction structural member was measured by the same method as in Example 1, and the same values in the thickness direction and the surface direction were obtained. The result is shown in Table 1.

### Comparative Example 2

(1) Manufacture of Ionic Conduction Structural Member

In this Comparative Example, an ionic conduction structural member was produced in the same manner as described in Example 1 with the exception that in place of the monomer having a polyethylene oxide group and a polypropylene oxide group in the side chain used in Example 1, a monomer having the number 2 of ethylene oxides in the polyethylene oxide group was used.

Methoxy-diethyleneoxy-block-eicosapropyleneoxy-acrylate (the number of ethylene oxide: 2, the number of propylene oxide: 20), which has the number of ethylene oxide 2 in polyethylene oxide group, (3.2 parts), methoxy-triethyleneoxy-methacrylate (the number of ethylene oxide: 3) used in Example 1, (2.0 parts) and crosslinking agent polyethylene glycol dimethacrylate (the number of ethylene oxide: 23) (0.6 parts) were added to the electrolyte solution obtained by mixing with propylene carbonate (50.0 parts), ethylene carbonate (50.0 parts) and an electrolyte lithium tetrafluoroborate (10.3 parts), and warmed to 40° C. with stirring well for obtaining a uniform solution. Subsequent process was performed in the same manner as in Example 1 to obtain a film-shaped ionic conduction structural member.

(2) Evaluation of Ionic Conduction Structural Member

The thus obtained ionic conduction structural member was measured in the same manner as described in Example 1 using a polarizing microscope, a viscoelasticity measurement apparatus and an X-ray small angle scattering measurement apparatus. As a result, the main chain part and side chain part of the polymer chain in the obtained ionic conduction structural member have no orientation property. The ionic conductivity of the thickness direction and the surface direction of the ionic conduction structural member was measured by the same method as in Example 1, and substantially the same values in the thickness direction and the surface direction were obtained. The result is shown in Table 1.

### Comparative Example 3

(1) Manufacture of Ionic Conduction Structural Member

In this Comparative Example, an ionic conduction structural member was produced in the same manner as described in Example 1 with the exception that in place of the monomer having polyethylene oxide group and polypropylene oxide group in the side chain used in Example 1, a monomer having the number 2 of propylene oxides in the polypropylene oxide group used.

Methoxy-eicosaethyleneoxy-block-dipropyleneoxy-acrylate (the number of ethylene oxide: 20, the number of propylene oxide: 2), which has the number of ethylene oxide 2 in a polypropylene oxide group (3.2 parts), methoxy-triethyleneoxy-methacrylate (the number of ethylene oxide: 3) used in Example 1 (2.0 parts) and a crosslinking agent, polyethylene glycol dimethacrylate (the number of ethylene oxide: 23) (0.6 parts) were added to the electrolyte solution obtained by mixing with propylene carbonate (50.0 parts), ethylene carbonate (50.0 parts) and an electrolyte lithium tetrafluoroborate (10.3 parts), and warmed to 40° C. with stirring well for obtaining a uniform solution. Subsequent process was performed in the same manner as in Example 1 to obtain a film-shaped ionic conduction structural member.

(2) Evaluation of Ionic Conduction Structural Member

The thus obtained ionic conduction structural member was measured in the same manner as described in Example 1 using a polarizing microscope, a viscoelasticity measurement apparatus and an X-ray small angle scattering measurement apparatus. As a result, the main chain part and side chain part of the polymer chain in the obtained ionic conduction structural member have no orientation property. The ionic conductivity of the thickness direction and the surface direction of the ionic conduction structural member was measured by the same method as in Example 1, and substantially the same values in the thickness direction and the surface direction were obtained. The result is shown in Table 1.

### Comparative Example 4

In this Comparative Example, an ionic conduction structural member was produced in the same manner as described in Example 1 with the exception that in place of the monomer having ethylene oxide group in the side chain used in Example 1, methyl methacrylate having no ethylene oxide group was used.

Methyl methacrylate having no ethylene oxide group (2.0 parts), methoxy-eicosaethyleneoxy-block-eicosapropyleneoxy-acrylate used in Example 1 (the number of ethylene oxide: 20, the number of propylene oxide: 20) (3.2 parts), and crosslinking agent polyethylene glycol dimethacrylate (the number of ethylene oxide: 23) (0.6 parts) were added to the electrolyte solution obtained by mixing with propylene carbonate (50.0 parts), ethylene carbonate (50.0 parts) and an electrolyte lithium tetrafluoroborate (10.3 parts), warmed to 40° C. with stirring well for obtaining a uniform solution. Subsequent process was performed as same as in Example 1 to prepare the ionic conduction structural member, however solvent which can not be contained in the ionic conduction structural member was generated, and the film-shaped ionic conduction structural member with strength could not be obtained, consequently the orientation and ionic conductivity could not be evaluated. The weight of solvent that could not be contained was measured, and was 30% by weight to the total weight of the mixed solvent before the polymerization.

### (Comparative Example 5

(1) Manufacture of Ionic Conduction Structural Member

In this Comparative Example, an ionic conduction structural member was produced in the same manner as described in Example 16 with the exception that the monomer having polyethylene oxide group and polypropylene oxide group in the side chain used in Example 16 was not used.

Methoxy-triethyleneoxy-methacrylate (the number of ethylene oxide: 3) used in Example 16 (5.2 parts) and polyethylene glycol dimethacrylate (the number of ethylene oxide: 23) (0.6 parts) were added to the electrolyte solution obtained by mixing with propylene carbonate (50.0 parts), ethylene carbonate (50.0 parts) and an electrolyte lithium tetrafluoroborate (10.3 parts), and warmed to 40° C. with stirring well for obtaining a uniform solution. Subsequent process was performed in the same manner as in Example 16 to obtain a film-shaped ionic conduction structural member.

(2) Evaluation of Ionic Conduction Structural Member

The thus obtained ionic conduction structural member was measured in the same manner as described in Example 1 using a polarizing microscope, a viscoelasticity measurement apparatus and an X-ray small angle scattering measurement apparatus. As a result, the main chain part and side chain part of the polymer chain in the obtained ionic conduction structural member have no orientation property. The ionic conductivity of the thickness direction and the surface direction of the ionic conduction structural member was measured by the same method as in Example 1, and the same values in the thickness direction and the surface direction were obtained. The result is shown in Table 1.

### (Comparative Example 6

(1) Manufacture of Ionic Conduction Structural Member

In this Comparative Example, an ionic conduction structural member was produced without using monomer but with using hydrophilic polymer. Straight chain polyacrylonitrile (10 parts), a plasticizer ethylene carbonate (40 parts), propylene carbonate (40 parts), and an electrolyte lithium tetrafluoroborate (10 parts) were mixed, and the mixture was inserted into the cell, which was constructed by 2 glass plates and Teflon (registered trade name) made spacer (thickness: 50 μm), and sealed. The cell was cooled to 0° C. to obtain a film-shaped ionic conduction structural member.

(2) Evaluation of Ionic Conduction Structural Member

The thus obtained ionic conduction structural member was measured in the same manner as described in Example 1 using a polarizing microscope, a viscoelasticity measurement apparatus and an X-ray small angle scattering measurement apparatus. As a result, the main chain part and side chain part of the polymer chain in the obtained ionic conduction structural member have no orientation property. The ionic conductivity of the thickness direction and the surface direction of the ionic conduction structural member was measured by the same method as in Example 1, and the same values in the thickness direction and the surface direction were obtained. The result is shown in Table 1.

(Overall Evaluation)

Table 1 is a summary of normalized orientation properties and ionic conductivities of the film-shaped ionic conduction structural members prepared in Examples 1 to 16 and Comparative Examples 1 to 6. The values shown in Table 1 have been obtained by normalizing the values obtained in Examples 2 to 16 and Comparative Examples 1 to 6 with the values obtained in Example 1 being used as the reference values. From the results described in Table 1, it can be seen that the film-shaped ionic conduction structural members of all Examples have orientation property and anisotropic ionic conductivity, and also have good ionic conductivity in the thickness direction.

TABLE 1

| | | | Orientation Property*¹ | | | | Ionic Conductivity*² | | |
|---|---|---|---|---|---|---|---|---|---|
| | | | Side chain | | Main chain | | Ionic | Ionic | Aniso- |
| | | | | Peak | | Peak in- | conduc- | conduc- | tropic |
| | | | Orientation | intensity | Orientation | tensity | tivity | tivity | ionic con- |
| | First Monomer | Second Monomer | direction | ratio | direction | ratio | at 25° C. | at −20° C. | ductivity |
| Exam- | Methoxy-icosaethyleneoxy- | Methoxy- | Direction | 5.5 | Direction | 6.0 | 1.0 | 1.0 | 8.0 |
| ple 1 | icosapropyleneoxy-acrylate | triethyleneoxy- | along | | parallel to | | | | |
| | (Number of ethylene oxides: | methacrylate | thickness | | film surface | | | | |
| | 20; Number of propylene | (Number of ethylene | | | | | | | |
| | oxides: 20) | oxides: 3) | | | | | | | |
| Exam- | Ethoxy-triacontaethyleneoxy- | Ethoxy- | Direction | 5.4 | Direction | 5.9 | 1.0 | 1.0 | 7.8 |
| ple 2 | decapropyleneoxy-acrylate | nonaethyleneoxy- | along | | parallel to | | | | |
| | (Number of ethylene oxides: | acrylate | thickness | | film surface | | | | |
| | 30; Number of propylene | (Number of ethylene | | | | | | | |
| | oxides: 10) | oxides: 9) | | | | | | | |
| Exam- | Methoxy-decaethyleneoxy- | Methoxy- | Direction | 5.5 | Direction | 5.9 | 1.0 | 1.0 | 7.9 |
| ple 3 | tetracontapropyleneoxy- | hexaethyleneoxy- | along | | parallel to | | | | |
| | methacrylate | methacrylate | thickness | | film surface | | | | |
| | (Number of ethylene oxides: | (Number of ethylene | | | | | | | |
| | 10; Number of propylene | oxides: 6) | | | | | | | |
| | oxides: 40) | | | | | | | | |
| Exam- | Ethoxy-hexacontaethyleneoxy- | Ethoxy- | Direction | 3.8 | Direction | 4.9 | 0.9 | 0.8 | 5.3 |
| ple 4 | pentapropyleneoxy- | diethyleneoxy- | along | | parallel to | | | | |
| | methacrylate | methacrylate | thickness | | film surface | | | | |
| | (Number of ethylene oxides: | (Number of ethylene | | | | | | | |
| | 60; Number of propylene | oxides: 2) | | | | | | | |
| | oxides: 5) | | | | | | | | |
| Exam- | Butoxy-pentaethyleneoxy- | Butoxy- | Direction | 3.6 | Direction | 4.8 | 0.8 | 0.7 | 5.1 |
| ple 5 | nonacontapropyleneoxy- | triacontaethyleneoxy | along | | parallel to | | | | |
| | acrylate | -acrylate | thickness | | film surface | | | | |
| | (Number of ethylene oxides: | (Number of ethylene | | | | | | | |
| | 5; Number of propylene | oxides: 30) | | | | | | | |
| | oxides: 90) | | | | | | | | |
| Exam- | Methoxy-pentaethyleneoxy- | Methoxy- | Direction | 3.5 | Direction | 5.1 | 0.8 | 0.8 | 5.6 |
| ple 6 | icosapropyleneoxy-acrylate | triethyleneoxy- | along | | parallel to | | | | |
| | (Number of ethylene oxides: 5; | methacrylate | thickness | | film surface | | | | |
| | Number of propylene oxides: | (Number of | | | | | | | |
| | 20) | ethylene oxides: | | | | | | | |
| Exam- | Methoxy-decaethyleneoxy- | 3) | Direction | 5.3 | Direction | 6.2 | 1.0 | 1.0 | 7.8 |
| ple 7 | icosapropyleneoxy-acrylate | | along | | parallel to | | | | |
| | (Number of ethylene oxides: | | thickness | | film surface | | | | |
| | 10; Number of propylene | | | | | | | | |
| | oxides: 20) | | | | | | | | |
| Exam- | Methoxy- | | Direction | 5.6 | Direction | 5.8 | 1.0 | 1.0 | 8.2 |
| ple 8 | pentacontaethyleneoxy- | | along | | parallel to | | | | |
| | icosapropyleneoxy-acrylate | | thickness | | film surface | | | | |
| | (Number of ethylene oxides: | | | | | | | | |
| | 50; Number of propylene | | | | | | | | |
| | oxides: 20) | | | | | | | | |
| Exam- | Methoxy-hectaethyleneoxy- | | Direction | 3.8 | Direction | 4.7 | 0.7 | 0.8 | 5.1 |
| ple 9 | icosapropyleneoxy-acrylate | | along | | parallel to | | | | |
| | (Number of ethylene oxides: | | thickness | | film surface | | | | |
| | 100; Number of propylene | | | | | | | | |
| | oxides: 20) | | | | | | | | |
| Exam- | Methoxy-icosaethyleneoxy- | | Direction | 3.3 | Direction | 4.1 | 0.7 | 0.7 | 4.8 |
| ple 10 | pentapropyleneoxy-acrylate | | along | | parallel to | | | | |
| | (Number of ethylene oxides: | | thickness | | film surface | | | | |
| | 20; Number of propylene | | | | | | | | |
| | oxides: 5) | | | | | | | | |
| Exam- | Methoxy-icosaethyleneoxy- | | Direction | 5.3 | Direction | 5.9 | 0.9 | 1.0 | 7.1 |
| ple 11 | decapropyleneoxy-acrylate | | along | | parallel to | | | | |
| | (Number of ethylene oxides: | | thickness | | film surface | | | | |
| | 20; Number of propylene | | | | | | | | |
| | oxides: 10) | | | | | | | | |
| Exam- | Methoxy-icosaethyleneoxy- | Methoxy- | Direction | 5.5 | Direction | 5.8 | 1.0 | 0.9 | 7.3 |
| ple 12 | pentacontapropyleneoxy- | triethyleneoxy- | along | | parallel to | | | | |
| | acrylate | methacrylate | thickness | | film surface | | | | |
| | (Number of ethylene oxides: | (Number of ethylene | | | | | | | |
| | 20; Number of propylene | oxides: 3) | | | | | | | |
| | oxides: 50) | | | | | | | | |
| Exam- | Methoxy-icosaethyleneoxy- | | Direction | 3.1 | Direction | 4.1 | 0.8 | 0.7 | 4.4 |
| ple 13 | hectapropyleneoxy-acrylate | | along | | parallel to | | | | |
| | (Number of ethylene oxides: | | thickness | | film surface | | | | |
| | 20; Number of propylene | | | | | | | | |
| | oxides: 100) | | | | | | | | |
| Exam- | Methoxy-icosapropyleneoxy- | Methoxy- | Direction | 5.4 | Direction | 5.7 | 1.1 | 1.1 | 7.6 |
| ple 14 | icosaethyleneoxy-acrylate | hectaethyleneoxy- | along | | parallel to | | | | |
| | (Number of propylene | acrylate | thickness | | film surface | | | | |
| | oxides: 20; Number of | (Number of ethylene | | | | | | | |
| | ethylene oxides: 20) | oxides: 100) | | | | | | | |
| Exam- | Methoxy- | Methoxy-ethoxy- | Direction | 4.3 | Direction | 4.7 | 0.7 | 0.7 | 6.2 |
| ple 15 | triacontapropyleneoxy- | methacrylate | along | | parallel to | | | | |
| | decaethyleneoxy-acrylate | (Number of ethylene | thickness | | film surface | | | | |
| | (Number of propylene | oxide: 1) | | | | | | | |
| | oxides: 30; Number of | | | | | | | | |
| | ethylene oxides: 10) | | | | | | | | |
| Exam- | Methoxy-icosaethyleneoxy- | Methoxy- | Direction | 5.3 | Direction | 5.5 | 0.9 | 1.0 | 7.4 |
| ple 16 | icosapropyleneoxy-acrylate | triethyleneoxy- | along | | parallel to | | | | |
| | (Number of ethylene oxides: | methacrylate | thickness | | film | | | | |
| | 20; Number of propylene | (Number of ethylene | | | surface | | | | |
| | oxides: 20) | oxides: 3) | | | | | | | |
| Com- | None | Methoxy- | None | 1.0 | None | 1.0 | 0.3 | 0.3 | 1.0 |
| parative | | triethyleneoxy- | | | | | | | |
| Exam- | | methacrylate | | | | | | | |
| ple 1 | | (The number of | | | | | | | |
| | | ethylene oxide 3) | | | | | | | |
| Com- | Methoxy-diethyleneoxy- | Methoxy- | None | 1.2 | None | 1.2 | 0.4 | 0.3 | 1.1 |
| parative | icosapropyleneoxy-acrylate | triethyleneoxy- | | | | | | | |
| Exam- | (Number of ethylene oxides: | methacrylate | | | | | | | |
| ple 2 | 2: Number of propylene | (The number of | | | | | | | |
| | oxides: 20) | ethylene oxide 3) | | | | | | | |
| Com- | Methoxy-icosaethyleneoxy- | Methoxy- | None | 1.1 | None | 1.1 | 0.3 | 0.4 | 1.1 |
| parative | dipropyleneoxy-acrylate | triethyleneoxy- | | | | | | | |
| Exam- | (Number of ethylene oxides: | methacrylate | | | | | | | |
| ple 3 | 20; Number of propylene | (The number of | | | | | | | |
| | oxides: 2) | ethylene oxide 3) | | | | | | | |
| Com- | Methoxy-icosaethyleneoxy- | methylmethacrylate | Not evaluated | | | | Not evaluated | | |
| parative | icosapropyleneoxy-acrylate | (No ethylene | | | | | | | |
| Exam- | (Number of ethylene oxides: | oxide) | | | | | | | |
| ple 4 | 20; Number of propylene | | | | | | | | |
| | oxides: 20) | | | | | | | | |
| Com- | None | Methoxy- | None | 1.0 | None | 1.0 | 0.3 | 0.3 | 1.0 |
| parative | | triethyleneoxy- | | | | | | | |
| Exam- | | methacrylate | | | | | | | |
| ple 5 | | (Number of | | | | | | | |
| | | ethylene oxides: | | | | | | | |
| | | 3) | | | | | | | |

| | | | | | | | | |
|---|---|---|---|---|---|---|---|---|
| Com- | Polyacrylonitrile used | None | 1.0 | None | 1.0 | 0.2 | 0.2 | 1.0 |
| parative | | | | | | | | |
| Exam- | | | | | | | | |
| ple 6 | | | | | | | | |

[Explanation for Items on Evaluation in Table 1]

*1. Orientation property: According to the method described in the item “Evaluation of the ionic conduction structural member” in Example 1, measurement was performed by using an X-ray small angle scattering measurement apparatus in every direction including the direction parallel to the film surface and the film thickness direction of the ionic conduction structural member, and the orientation direction was defined as the direction having the highest peak intensity corresponding to each of the side chain part and the main chain part. The peak intensity ratio is defined as the ratio of the peak intensity in the direction having the highest peak intensity to the peak intensity in the direction having the lowest peak intensity.

*2. Ionic conductivity: According to the method described in the item on “Evaluation of ionic conduction structure” in Example 1, the impedance in the thickness direction of the ionic conduction structure was measured at 25° C. and at −20° C., and the ionic conductivity was calculated from the impedance value, respectively. For Examples 2 to 16 and Comparative Examples 1 to 6, the values obtained therein were each normalized with the value obtained in Example 1 being defined as 1.0 and comparative evaluation was performed.

The anisotropic ionic conductivity was evaluated by measuring the ionic conductivities in the thickness direction and in the film surface direction of the ionic conduction structural member according to the method described in the item on “Evaluation of ionic conduction structural member” in Example 1 and representing the ratio of the ionic conductivity in the thickness direction to that in the film surface direction as follows. The measurement of the ionic conductivity for each direction was performed according to the method described in Example 1.
Anisotropic ionic conductivity=(the ionic conductivity in a direction perpendicular to the film surface of the ionic conduction structural member)/(the ionic conductivity in a direction parallel to the film surface of the ionic conduction structural member)

### Examples 17 to 19

A sheet type secondary battery shown in FIG. 4 was produced using the mixed solution prepared in Examples 1, 11 and 14 according to the following procedures. In Example 17, the mixed solution prepared in Example 1 was used; in Example 18, the mixed solution prepared in Example 11 was used; and in Example 19, the mixed solution prepared in Example 14 was used. Concretely, in Examples 17 to 19, at first, the negative electrode and the positive electrode were produced, and the thus obtained negative electrode and positive electrode were bonded in opposition to the both surfaces of a porous film as the support, which was then impregnated with the mixed solution containing the monomer having alkyl group and polyether group in the side chain, solvent and electrolyte and was sealed with a moisture-proof film as a laminate film of polypropylene/aluminum foil/polyethylene terephthalate, and the monomer was polymerized to manufacture a sheet type secondary battery. The procedure for manufacture of the sheet type secondary battery will be explained with reference to FIG. 4 as follows.

(1) Manufacture of Negative Electrode 404:

Polyfluorovinylidene powder (10 parts) was mixed with fine powder of natural graphite (90 parts) heat treated at 2000° C. under an argon gas atmosphere, and N-methyl-2-pyrrolidone (100 parts) was added thereto to prepare the paste. The thus obtained paste was coated on the copper foil as the current collector 402, and dried in vacuo at 150° C. Then, the obtained product was cut into a desired size, and a nickel wire lead was connected thereto by spot welding to obtain the negative electrode 404.

(2) Manufacture of Positive Electrode 407:

Acetylene black (5. parts) and polyvinylidene fluoride (5 parts) were mixed with lithium cobaltate powder (90 parts), and thereto was added N-methyl-2-pyrrolidone (100 parts) to prepare a paste. The obtained paste was coated on an aluminum foil as the current collector 406 and dried, and then the positive electrode active material layer was pressed by using a roll press machine. The obtained was cut into a desired size, and then an aluminum lead wire was connected thereto by an ultrasonic welding machine, and dried in vacuo at 150° C. to obtain the positive electrode 407.

(3) Assembling Secondary Battery:

The assembly of the secondary battery was performed under an argon gas atmosphere.

The negative electrode obtained in the above (1) and the positive electrode obtained in the above (2) were placed on the both sides of a polyethylene porous film with the active material layers of the both electrode facing each other. In Example 17, a mixed solution prepared by dissolving methoxy-eicosaethyleneoxy-block-eicosapropyleneoxy-acrylate (the number of ethylene oxide: 20, the number of propylene oxide: 20) (3.2 parts), methoxy-triethyleneoxy-methacrylate (the number of ethylene oxide: 3) (2.0 parts), polyethylene glycol dimethacrylate (the number of ethylene oxide: 23) (0.6 parts) and a radical polymerization initiator azobisisobutyronitrile (0.002 parts) in an electrolyte solution obtained by mixing propylene carbonate (50.0 parts), ethylene carbonate (50.0 parts) and an electrolyte lithium tetrafluoroborate (10.3 parts); in Example 18, the mixed solution prepared in Example 11; and in Example 19, the mixed solution prepared in Example 14, was each inserted between the negative electrode and the positive electrode of the electrode stack. Subsequently, the electrode stack was sealed with the moisture-proof film as the laminate film of polypropylene/aluminum foil/polyethylene terephthalate, and was then heated at 70° C. for 1 hour to effect a polymerization reaction. Thus, three sheet type batteries were produced.

The three sheet type batteries obtained in Examples 17 to 19 were evaluated by a capacity test and a charge/discharge cycle life test to obtain a higher capacity and a better cycle life, compared to the Comparative Examples. The results are shown in Table 2.

### Example 20

In this example, a treatment for incorporating an ionic conduction structural member into the negative electrode and the positive electrode produced by the same procedure as in Examples 17 to 19 was performed as described hereinbelow to manufacture the sheet type battery.

(Treatment of Negative Electrode and Positive Electrode)

A mixed solution (140 parts), which was prepared by mixing methoxy-eicosaethyleneoxy-block-eicosapropyleneoxy-acrylate (the number of ethylene oxide: 20, the number of propylene oxide: 20) (3.2 parts), methoxy-triethyleneoxy-methacrylate (the number of ethylene oxide: 3) (2.0 parts), polyethylene glycol dimetacrylate (the number of ethylene oxide: 23) (0.6 parts) and a radical polymerization initiator 1-hydroxycyclohexylphenyl ketone (0.04 parts) with a 1 mol/dm³ electrolyte solution of lithium tetrafluoroborate dissolved in a mixed solvent of propylene carbonate and dimethyl carbonate (1:1 (v/v)), was impregnated into a negative electrode and a positive electrode produced by the same procedure as in Example 17, and was subjected to a polymerization reaction by irradiation with ultraviolet ray (10 mW/cm²) for 1 hour to form an ionic conduction structural member in the electrode active material layer of each of the negative electrode and the positive electrode. Incidentally, the monomer used in the above was a product having a uniform molecular weight obtained by column chromatographic separation.

As with Examples 17 to 19, the above treated negative electrode and positive electrode were placed on the both sides of a polyethylene porous film with the electrode active material layers thereof facing each other. The mixed solution used in Example 17 was inserted between the negative electrode and the positive electrode of the electrode stack. Subsequently, the electrode stack was sealed with a moisture-proof film as a laminate film of polypropylene/aluminum foil/polyethylene terephthalate. Thereafter, the sealed stack was heated at 70° C. for 1 hour to effect a polymerization reaction, thereby manufacturing a sheet type battery having the construction as shown in FIG. 4.

The thus obtained sheet type secondary battery was evaluated by a capacity test and a charge/discharge cycle life test to obtain a higher capacity and a better cycle life, compared to the Comparative Examples. The results are shown in Table 2.

### Example 21

In this example, a negative electrode and a positive electrode were produced following the same procedure as in Examples 17 to 19, and an ionic conduction structural member was formed between the thus produced negative electrode and positive electrode, which were produced by the same procedure as in Example 17, as described below to manufacture a sheet type battery.

A spacer of silica beads (particle size 50 μm) was coated on the electrode active material layer of the negative electrode, and the positive electrode was positioned such that the electrode active material layers of the both electrodes are in opposition to each other. Between the negative electrode and the positive electrode of the electrode stack, a mixed solution, which was prepared by dissolving methoxy-eicosapropyleneoxy-block-eicosaethyleneoxy-acrylate (the number of propylene oxide: 20, the number of ethylene oxide: 20) (1.58 parts), methoxy-hectaethyleneoxy-acrylate (the number of ethylene oxide: 100) (3.35 parts), polyethylene glycol dimethacrylate (the number of ethylene oxide: 13) (0.27 parts) and a radical polymerization initiator azobisisobutyronitrile (0.002 parts) in an electrolyte solution obtained by mixing diethoxy carbonate (50.0 parts), ethylene carbonate (50.0 parts) and an electrolyte lithium hexafluorophosphate (10.3 parts), was inserted. Then, the electrode stack was heated at 70° C. to effect a polymerization reaction for 1 hour. Thereafter, the electrode stack was sealed with a moisture-proof film as a laminate film of polypropylene/aluminum foil/polyethylene terephthalate to manufacture a sheet type secondary battery. The monomer used in the above was a product having a uniform molecular weight obtained by column chromatographic separation.

The thus obtained sheet type battery was evaluated by a capacity test and a charge/discharge cycle life test to obtain a higher capacity and a better cycle life, compared to the Comparative Examples. The results are shown in Table 2.

### Example 22

In this example, a negative electrode and a positive electrode, which were treated as in Example 20, were used, and the ionic conduction structural member produced in Example 1 was used to prepare a sheet type secondary battery as follows.

The negative electrode and the positive electrode were bonded in opposition to the both surfaces of the ionic conduction structural member produced in Example 1, and was sealed with a moisture-proof film as a laminate film of polypropylene/aluminum foil/polyethylene terephthalate to manufacture a sheet type secondary battery.

The thus obtained sheet type battery was evaluated by a capacity test and a charge/discharge cycle life test to obtain a higher capacity and a better cycle life, compared to the Comparative Examples. The results are shown in Table 2.

### Comparative Example 6

In this Comparative Example, the mixed solution prepared in Comparative Example 1 was used to manufacture a sheet type battery by following the same procedure as described in Example 17. The obtained sheet type battery was evaluated by a charge/discharge test, and was found to have a smaller capacity and a shorter cycle life as compared with the examples, especially the capacity at a low temperature was significantly decreased. The results are shown in Table 2.

### Comparative Example 7

In this Comparative Example, a sheet type secondary battery was produced following the same procedure as in Example 22 with the exception that the ionic conduction structural member produced in Comparative Example 1 was used in place of the ionic conduction structural member used in Example 22. The thus obtained sheet type secondary battery was evaluated by a charge/discharge test, and was found to have a smaller capacity and a shorter cycle life as compared with the examples, especially the capacity at a low temperature was significantly decreased. The results are shown in Table 2.

### Comparative Example 8

In this Comparative Example, an electrolyte solution was used in place of the ionic conduction structural member, and a sheet type secondary battery was produced by the following method. That is, a negative electrode and a positive electrode were produced following the same procedure as in Examples 17 to 19, and the negative electrode and the positive electrode were bonded in opposition to each other to the both surfaces of a polyethylene porous membrane, and the bonded member was impregnated and maintained with 1 mol/L of an electrolyte solution prepared by dissolving lithium tetrafluoroborate in a mixed solvent of propylene carbonate and dimethyl carbonate (1:1 (v/v)), and sealed with a moisture-proof film as a laminate film of polypropylene/aluminum foil/polyethylene terephthalate to manufacture a sheet type secondary battery. The thus obtained sheet type secondary battery was evaluated by a capacity test and a charge/discharge cycle life test. The results are shown in Table 2.

(Overall Evaluation)

Table 2 is a summary of the charge/discharge performance of the secondary batteries produced in Examples 17 to 22 and Comparative Examples 6 to 8. The values shown in Table 2 are relative values normalized with the results of Example 17 being 1.0 as the reference value. It can be seen from the results shown in Table 2 that the secondary batteries of the Examples each have good capacity and cycle life, and the capacity at discharge with a large current is remarkably excellent. Further, it can be seen that the secondary batteries of the Examples each have a charge/discharge characteristic comparable to that of the secondary battery of the liquid system using the electrolyte solution of Comparative Example 8, even at a low temperature.

TABLE 2

| | Capacity test at 25° C.^{*3} | | | |
|---|---|---|---|---|
| | Capacity at | Capacity at | Capacity | |
| | 1 C | 3 C | test at | |
| | discharge | discharge | −20° C.^{*3} | Cycle life^{*4} |
| Example 17 | 1.0 | 1.0 | 1.0 | 1.0 |
| Example 18 | 1.0 | 1.0 | 1.0 | 0.9 |
| Example 19 | 1.0 | 1.1 | 1.1 | 1.1 |
| Example 20 | 1.0 | 1.0 | 1.1 | 1.1 |
| Example 21 | 1.0 | 0.9 | 0.9 | 0.9 |
| Example 22 | 1.1 | 1.1 | 1.1 | 1.0 |
| Comparative | 0.8 | 0.4 | 0.3 | 0.7 |
| Example 6 | | | | |
| Comparative | 0.9 | 0.5 | 0.4 | 0.8 |
| Example 7 | | | | |
| Comparative | 1.2 | 1.2 | 1.2 | 1.1 |
| Example 8 | | | | |

(Explanation of Items for Evaluation in Table 2)
*3. Capacity Test
Capacity Test at 25° C.:

An operation in which after each of the secondary batteries was charged at 25° C. with a current value of 0.2C (current value of 0.2×(battery capacity calculated from amount of positive electrode active material)/hour, namely a current value when the whole capacity of the battery is charged or discharged for a period of 5 hours with a constant current) for 5 hours, the battery was discharged with the same current value to 2.5 V was set as one cycle, and this cycle was repeated 3 times (1st to 3rd cycles). Thereafter, in a 4th cycle, the battery was charged with a current value of 0.2C at 25° C. for 5 hours and then discharged at 25° C. with a current value of 1C (current value of 1×(battery capacity calculated from amount of positive electrode active material)/hour) to 2.5 V. The ratio of the discharge capacity to the charge capacity at the 4th cycle was evaluated as follows and was defined as the capacity at 1C.

Subsequently, a charge/discharge test in which each battery is charged for 5 hours at a current value of 0.2C at 25° C. and then discharged with the same current value to 2.5 V was set as 1 cycle, and this charge/discharge cycle was repeated 3 times (5th to 7th cycles). Thereafter, in a 8th cycle, the battery was charged with a current value of 0.2C at 25° C. for a period of 5 hours, and then discharged at 25° C. with a current value of 3C (a current value of 3×(battery capacity calculated from amount of positive electrode active material)/hour) to 2.5 V. The ratio of the discharge capacity to the charge capacity at the 8th cycle was evaluated as follows and was defined as the capacity at 3C.

(Capacity at 1C)=(amount of discharge at 4th cycle (mAh))/(amount of charge at 4th cycle (mAh))

(Capacity at 3C)=(amount of discharge at 8th cycle (mAh))/(amount of charge at 8th cycle (mAh))

Incidentally, the values for Examples 18 to 22 and Comparative Examples 6 to 8 are relative values obtained by normalization with the capacities at 1C and 3C for Example 17 each being defined as the reference value.

Capacity Test at −20° C.:

After the above capacity test at 25° C. (1st to 8th cycles), in a 9th cycle, each of the batteries was charged with a current value of 0.2C at 25° C. for a period of 5 hours, then cooled to −20° C., and discharged at −20° C. with a current value of IC to 2.5 V. The ratio of the discharge capacity to the charge capacity at the 9th cycle was evaluated as follows and was defined as the capacity at −20° C.

Capacity at −20° C.=amount of discharge at 9th cycle (mAh)/amount of charge at 9th cycle (mAh)

Incidentally, the values for Examples 18 to 22 and Comparative Examples 6 to 8 are relative values obtained by normalization with the capacity at −20° C. for Example 17 being defined as the reference value.

*4. Cycle Life

The cycle life was evaluated as follows. The amount of discharge in the 3rd cycle obtained in the capacity test at 25° C. above was set as a standard; a charge/discharge test consisting of charge/discharge at a current value of 0.5C and a rest for 10 minutes was defined as 1 cycle; this cycle was repeated; and evaluation was made by the number of cycles at which 60% of the battery capacity was not reached.

Incidentally, the values for Examples 18 to 22 and Comparative Examples 6 to 8 are relative values obtained by normalization with the value for Example 17 being defined as 1.0.

As explained above, according to preferable examples of the present invention, the ionic conduction structural member having a high ionic conductivity and an excellent mechanical strength can be obtained. Further, by applying the ionic conduction structural member of the present invention to a secondary battery, the secondary battery with a long cycle life, a high energy density and less deterioration of performance can be obtained. Moreover, according to the preferable examples of the present invention, the ionic conduction structural member and the secondary battery can easily be produced.

1. An ionic conduction structural member with a crosslinked structure comprising a polymer matrix, a solvent as a plasticizer and an electrolyte, wherein the polymer matrix comprises a polymer chain comprising a segment represented by the following general formula (1) and a segment represented by the following general formula (2): 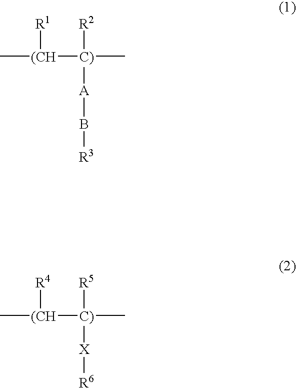
(wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more), and wherein a main chain part of the polymer chain and the side chain part of the general formula (1) have an orientation property.

2. The ionic conduction structural member according to claim 1, wherein the ratio of the —CH₂—CH₂—O— group and the —CH₂—CH(CH₃)—O— group contained in the polymer matrix represented by (the total number of the —CH₂—CH₂—O— groups contained in the entire polymer matrix)/(the total number of the —CH₂—CH(CH₃)—O— groups contained in the entire polymer matrix) is 0.5 to 20.

3. The ionic conduction structural member according to claim 1, wherein the ratio of the —CH₂—CH₂—O group and the —CH₂—CH(CH₃)—O— group contained in the polymer matrix represented by (the total number of the CH₂—CH₂—O— groups contained in the entire polymer matrix)/(the total number of —CH₂—CH(CH₃)—O— groups contained in the entire polymer matrix) is 1.0 to 10.

4. The ionic conduction structural member according to claim 1, wherein m and n of the general formula (1) are independently an integer of 5 to 100.

5. The ionic conduction structural member according to claim 1, wherein m and n of the general formula (1) are independently an integer of 10 to 50.

6. The ionic conduction structural member according to claim 1, wherein k of the general formula (2) is an integer of 2 to 100.

7. The ionic conduction structural member according to claim 1, wherein k of the general formula (2) is an integer of 3 to 30.

8. The ionic conduction structural member according to claim 1, wherein the orientation direction of the side chain part of the general formula (1) is perpendicular to the orientation direction of the main chain part of the polymer chain.

9. The ionic conduction structural member according to claim 1, which has an anisotropic ionic conductivity.

10. The ionic conduction structural member according to claim 1, wherein the content of the solvent as the plasticizer in the ionic conduction structural member is 70 to 99% by weight.

11. The ionic conduction structural member according to claim 1, wherein the content of the solvent as the plasticizer in the ionic conduction structural member is 80 to 99% by weight.

12. The ionic conduction structural member according to claim 1, wherein the solvent as the plasticizer is an aprotic polar solvent.

13. The ionic conduction structural member according to claim 12, wherein the aprotic polar solvent is at least one solvent selected from the group consisting of ethers, carbonates, nitrites, amides, esters, nitro compounds, sulfur compounds and halides.

14. The ionic conduction structural member according to claim 1, wherein the electrolyte is a salt of an alkali metal.

15. The ionic conduction structural member according to claim 14, wherein the salt of an alkali metal is a lithium salt.

16. The ionic conduction structural member according to claim 1, further comprising a support comprising at least one selected from the group consisting of resin powder, glass powder, ceramic powder, nonwoven fabric and a porous film.

17. The ionic conduction structural member according to claim 16, wherein the content of the support in the ionic conduction structural member is 1 to 50% by weight.

18. A method of producing an ionic conduction structural member comprising a polymer matrix, a solvent as a plasticizer and an electrolyte, which comprises, in sequence, the steps of:
(a) mixing a monomer represented by the following general formula (3) and a monomer represented by the following general formula (4): 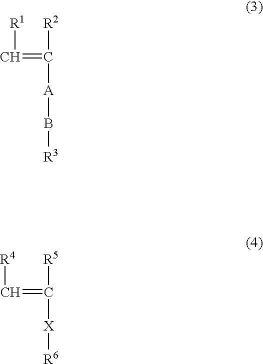
(wherein R¹, R², R⁴ and R⁵ are independently H or an alkyl group of 2 or less carbon atoms; R³ and R⁶ are independently an alkyl group of 4 or less carbon atoms; one of A and B is a group comprising —(CH₂—CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more) with a solvent and an electrolyte; and
(b) subjecting the mixture obtained by the step (a) to a polymerization reaction to prepare a polymer matrix.

19. The method of producing an ionic conduction structural member according to claim 18, wherein in the step (a), a polymerization initiator is mixed.

20. The method of producing an ionic conduction structural member according to claim 18, further comprising the step of forming a crosslinked structure in the polymer matrix by a crosslinking reaction.

21. The method of producing an ionic conduction structural member according to claim 20, wherein the crosslinked structure is formed by covalent bonding.

22. The method of producing an ionic conduction structural member according to claim 20, wherein in the step (a), a monomer which forms the crosslinked structure by the crosslinking reaction is mixed.

23. The method of producing an ionic conduction structural member according to claim 22, wherein the crosslinking reaction is the polymerization reaction in the step (b).

24. The method of producing an ionic conduction structural member according to claim 18, wherein m and n of the general formula (3) are independently an integer of 5 to 100.

25. The method of producing an ionic conduction structural member according to claim 18, wherein m and n of the general formula (3) are independently an integer of 10 to 50.

26. The method of producing an ionic conduction structural member according to claim 18, wherein k of the general formula (4) is an integer of 2 to 100.

27. The method of producing an ionic conduction structural member according to claim 18, wherein k of the general formula (4) is an integer of 3 to 30.

28. The method of producing an ionic conduction structural member according to claim 18, wherein in the step (a), the monomer of the general formula (3) and the monomer of the general formula (4) are mixed such that (the total number of the —CH₂—CH₂—O— groups contained in the entire polymer matrix)/(the total number of the —CH₂—CH(CH₃)—O— groups contained in the entire polymer matrix) is 0.5 to 20.

29. The method of producing an ionic conduction structural member according to claim 18, wherein in the step (a), the monomer of the general formula (3) and the monomer of the general formula (4) are mixed such that (the total number of the —CH₂—CH₂—O— groups contained in the entire polymer matrix)/(the total number of —CH₂—CH(CH₃)—O— groups contained in the entire polymer matrix) is 1.0 to 10.

30. The method of producing an ionic conduction structural member according to claim 18, wherein the solvent is an aprotic polar solvent.

31. The method of producing an ionic conduction structural member according to claim 30, wherein the aprotic polar solvent is at least one solvent selected from the group consisting of ethers, carbonates, nitrites, amides, esters, nitro compounds, sulfur compounds and halides.

32. The method of producing an ionic conduction structural member according to claim 18, wherein the electrolyte is a salt of an alkali metal.

33. The method of producing an ionic conduction structural member according to claim 32, wherein the salt of an alkali metal is a lithium salt.

34. The method of producing an ionic conduction structural member according to claim 18, wherein the polymerization reaction uses a thermal energy.

35. The method of producing an ionic conduction structural member according to claim 18, further comprising the step of incorporating, into the ionic conduction structural member produced, a support comprising at least one selected from the group consisting of resin powder, glass powder, ceramic powder, nonwoven fabric and a porous film.

36. The method of producing an ionic conduction structural member according to claim 35, wherein the content of the support in the ionic conduction structural member is 1 to 50% by weight.

37. A secondary battery comprising an ionic conductor between a positive electrode comprising an active material layer and a negative electrode comprising an active material layer provided in opposition to each other, wherein the ionic conduction structural member as set forth in any one of claims 1 to 17 is used as the ionic conductor and is disposed such that the ionic conductivity is higher in a direction connecting a surface of the negative electrode and a surface of the positive electrode.

38. The secondary battery according to claim 37, wherein at least one of the negative electrode and the positive electrode comprises the ionic conduction structural member.

39. The secondary battery according to claim 37, wherein the negative electrode active material layer comprises an active material having the function of incorporating lithium ions in a charging reaction and releasing lithium ions in a discharging reaction and the positive electrode active material layer comprises an active material having the function of releasing lithium ions in the charging reaction and incorporating lithium ions in the discharging reaction.

40. The secondary battery according to claim 37, wherein the negative electrode active material comprises at least one selected from the group consisting of metallic lithium, a metal capable of alloying with lithium deposited in a charging reaction and a compound capable of intercalating lithium ions in a charging reaction and deintercalating lithium ions in a discharging reaction, and the positive electrode active material comprises a material capable of deintercalating lithium ions in the charging reaction and intercalating lithium ions in the discharging reaction.

41. The secondary battery according to claim 40, wherein the negative electrode active material comprises at least one selected from the group consisting of metallic lithium, carbon materials including graphite, a metal capable of alloying electrochemically with lithium, tin oxide, a transition metal oxide, a transition metal nitride, a lithium/tin oxide, a lithium/transition metal oxide, a lithium/transition metal nitride, a transition metal sulfide, a lithium/transition metal sulfide, a transition metal carbide and a lithium/transition metal carbide.

42. The secondary battery according to claim 40, wherein the positive electrode active material comprises at least one selected from the group consisting of a transition metal oxide, a transition metal nitride, a lithium/tin oxide, a lithium/transition metal oxide, a lithium/transition metal nitride, a transition metal sulfide, a lithium/transition metal sulfide, a transition metal carbide and a lithium/transition metal carbide.

43. A method of producing a secondary battery comprising an ionic conductor between a positive electrode comprising an active material layer and a negative electrode comprising an active material layer provided in opposition to each other, which comprises the steps of forming, as the ionic conductor, an ionic conduction structural member by the method of producing an ionic conduction structural member as set forth in any one of claims 18 to 36 and disposing the ionic conduction structural member such that the ionic conductivity is higher in a direction connecting a surface of the negative electrode and a surface of the positive electrode.

44. The method of producing a secondary battery according to claim 43, which comprises forming the ionic conduction structural member on at least one of the negative electrode and the positive electrode, and disposing the negative electrode and the positive electrode in opposition to each other with the formed ionic conduction structural member therebetween.

45. The method of producing a secondary battery according to claim 43, wherein the ionic conduction structural member is an ionic conduction structural member with a crosslinked structure comprising a polymer matrix, a solvent as a plasticizer and an electrolyte, wherein the polymer matrix comprises a polymer chain comprising a segment represented by the following general formula (1) and a segment represented by the following general formula (2): 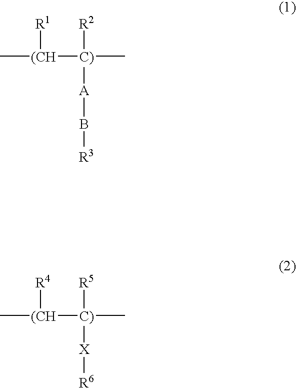
(wherein R¹, R², R⁴ and R⁵ are independently H or an alkyl group of 2 or less carbon atoms: R³ and R⁶ are independently an alkyl group of 4 or less carbon atoms; one of A and B is a group comprising —(CH₂CH₂—O)ₘ— and the other is a group comprising —(CH₂—CH(CH₃)—O)ₙ—, A and B each forming a block; X is a group comprising —(CH₂—CH₂—O)ₖ—; m and n are independently an integer of 3 or more; and k is an integer of 1 or more), and wherein a main chain part of the polymer chain and the side chain part of the general formula (1) have an orientation property.

46. The method of producing a secondary battery according to claim 43, comprising the step of incorporating the ionic conduction structural member into the negative electrode active material layer or the positive electrode active material layer to form the negative electrode or the positive electrode.

47. The method of producing a secondary battery according to claim 46, wherein the step of forming the negative electrode or the positive electrode comprises impregnating a polymer, a monomer or an oligomer capable of forming the ionic conduction structural member into a negative electrode active material or a positive electrode active material to form the negative electrode active material layer or the positive electrode active material layer containing the ionic conduction structural member.

48. The method of producing a secondary battery according to claim 47, wherein the formation of the ionic conduction structural member is performed by a polymerization reaction or a crosslinking reaction.

49. The method of producing a secondary battery according to claim 46, which comprises mixing the ionic conduction structural member with a negative electrode active material or a positive electrode active material and forming the negative electrode active material layer or the positive electrode active material layer on a current collector to form the negative electrode or the positive electrode.
